(19) United States
(12) Patent Application Publication
(10) Pub. No.: US 2021/0280900 A1
(43) Pub. Date: Sep. 9, 2021

(54) Method For Producing Solid Composition And Method For Producing Solid Electrolyte

(71) Applicant: Seiko Epson Corporation, Tokyo (JP)

(72) Inventors: Tomofumi YOKOYAMA, Matsumoto (JP); Hitoshi YAMAMOTO, Chino (JP); Naoyuki TOYODA, Suwa (JP)

(21) Appl. No.: 17/191,770

(22) Filed: Mar. 4, 2021

(30) Foreign Application Priority Data
Mar. 5, 2020 (JP) 2020-037832

(51) Int. Cl. H01M 10/0562

(52) U.S. Cl. CPC H01M 10/0562; H01M 2300/0071

(57) ABSTRACT

A method for producing a solid composition according to the present disclosure is a method for producing a solid composition to be used for forming a solid electrolyte having a first crystal phase, and includes producing an oxide constituted by a second crystal phase that is different from the first crystal phase at normal temperature and normal pressure, and mixing the oxide with an oxoacid compound.

The present application is based on, and claims priority from JP Application Serial Number 2020-037832, filed on Mar. 5, 2020, the disclosure of which is hereby incorporated by reference herein in its entirety.

### BACKGROUND

### 1. Technical Field

The present disclosure relates to a method for producing a solid composition and a method for producing a solid electrolyte.

### 2. Related Art

As a secondary battery using a solid electrolyte, for example, an all-solid-state lithium secondary battery including a positive electrode, a negative electrode, and a solid electrolyte containing a ceramic composed of lithium, lanthanum, zirconium, and oxygen and having a garnet-type or garnet-like crystal structure is known (see, for example, JP-A-2010-45019 (Patent Document 1)).

Patent Document 1 discloses a method for producing a solid electrolyte material, in which a raw material containing a Li component, a La component, and a Zr component is subjected to a heat treatment at a temperature higher than 1125° C. and lower than 1230° C. for 30 hours or more and 50 hours or less, thereby obtaining a ceramic composed of Li, La, Zr, and O and having a garnet-type or garnet-like crystal structure. Further, Patent Document 1 discloses that Li₂CO₃ is used as the Li component, La(OH)₃ or La₂O₃ is used as the La component, and ZrO₂ is used as the Zr component. Further, Patent Document 1 describes that in the chemical formulation of the solid electrolyte obtained as described above, the molar ratio of Li is stoichiometrically equivalent to or less than that of Li₇La₃Zr₂O₁₂ which is a garnet-type ceramic, and therefore, the chemical formulation is represented by Li₇₋ₓLa₃Zr₂O₁₂ (0≤x≤1.0).

However, when a high-temperature and long-time heat treatment as described above is performed, Li is volatilized, and it becomes difficult to obtain a designed formulation. As a result, it was difficult to realize a desired property, particularly, a desired lithium ion conductivity in the obtained solid electrolyte.

### SUMMARY

The present disclosure has been made for solving the above problem and can be realized as the following application examples.

A method for producing a solid composition according to an application example of the present disclosure is a method for producing a solid composition to be used for forming a solid electrolyte having a first crystal phase, and includes

producing an oxide constituted by a second crystal phase that is different from the first crystal phase at normal temperature and normal pressure, and

mixing the oxide with an oxoacid compound.

Further, a method for producing a solid electrolyte according to an application example of the present disclosure includes

producing a solid composition by the method for producing a solid composition according to the present disclosure, and

heating the solid composition at a temperature of 700° C. or higher and 1000° C. or lower.

### BRIEF DESCRIPTION OF THE DRAWINGS

FIG. 1 is a schematic perspective view schematically showing a configuration of a lithium-ion battery as a secondary battery of a first embodiment.

FIG. 2 is a schematic perspective view schematically showing a configuration of a lithium-ion battery as a secondary battery of a second embodiment.

FIG. 3 is a schematic cross-sectional view schematically showing a structure of the lithium-ion battery as the secondary battery of the second embodiment.

FIG. 4 is a schematic perspective view schematically showing a configuration of a lithium-ion battery as a secondary battery of a third embodiment.

FIG. 5 is a schematic cross-sectional view schematically showing a structure of the lithium-ion battery as the secondary battery of the third embodiment.

FIG. 6 is a schematic perspective view schematically showing a configuration of a lithium-ion battery as a secondary battery of a fourth embodiment.

FIG. 7 is a schematic cross-sectional view schematically showing a structure of the lithium-ion battery as the secondary battery of the fourth embodiment.

FIG. 8 is a flowchart showing a method for producing the lithium-ion battery as the secondary battery of the first embodiment.

FIG. 9 is a schematic view schematically showing the method for producing the lithium-ion battery as the secondary battery of the first embodiment.

FIG. 10 is a schematic view schematically showing the method for producing the lithium-ion battery as the secondary battery of the first embodiment.

FIG. 11 is a schematic cross-sectional view schematically showing another method for forming a solid electrolyte layer.

FIG. 12 is a flowchart showing a method for producing the lithium-ion battery as the secondary battery of the second embodiment.

FIG. 13 is a schematic view schematically showing the method for producing the lithium-ion battery as the secondary battery of the second embodiment.

FIG. 14 is a schematic view schematically showing the method for producing the lithium-ion battery as the secondary battery of the second embodiment.

FIG. 15 is a flowchart showing a method for producing the lithium-ion battery as the secondary battery of the third embodiment.

FIG. 16 is a schematic view schematically showing the method for producing the lithium-ion battery as the secondary battery of the third embodiment.

FIG. 17 is a schematic view schematically showing the method for producing the lithium-ion battery as the secondary battery of the third embodiment.

FIG. 18 is a flowchart showing a method for producing the lithium-ion battery as the secondary battery of the fourth embodiment.

FIG. 19 is a schematic view schematically showing the method for producing the lithium-ion battery as the secondary battery of the fourth embodiment.

FIG. 20 is a graph showing X-ray diffraction patterns of precursor oxides constituting solid compositions according to respective Examples and Comparative Example.

FIG. 21 is a graph showing X-ray diffraction patterns of solid electrolytes according to respective Examples and Comparative Example.

### DESCRIPTION OF EXEMPLARY EMBODIMENTS

Hereinafter, preferred embodiments of the present disclosure will be described in detail.

### [1] Solid Composition

First, prior to a method for producing a solid composition according to the present disclosure, a solid composition according to the present disclosure, that is, a solid composition produced using a method for producing a solid composition according to the present disclosure will be described.

The solid composition according to the present disclosure is one produced using a method for producing a solid composition according to the present disclosure, which will be described in detail later.

Such a solid composition is used for forming a solid electrolyte having a first crystal phase. Then, the solid composition contains an oxide constituted by a second crystal phase that is different from the first crystal phase at normal temperature and normal pressure, and an oxoacid compound. The solid composition contains lithium.

According to this, by a heat treatment at a relatively low temperature for a relatively short time, a solid composition capable of stably forming a solid electrolyte having a desired property can be provided. More specifically, by containing an oxoacid compound in the solid composition, the melting point of the oxide is lowered, and a close contact interface with an adherend can be formed while promoting the crystal growth in a firing treatment that is a heat treatment at a relatively low temperature for a relatively short time. Further, due to an action capable of causing a reaction of incorporating lithium ions in the oxide contained in the solid composition during the reaction, a solid electrolyte that is a lithium-containing composite oxide can be formed at a low temperature. Therefore, for example, a decrease in the ion conductivity due to volatilization of lithium ions that has been a problem in the related art can be suppressed, and an effect of being able to produce an all-solid-state battery having excellent battery capacity at a high load is obtained.

On the other hand, when the conditions as described are not satisfied, satisfactory results are not obtained.

For example, when the solid composition does not contain an oxoacid compound, the effect of lowering the melting point of the oxide is not obtained, and in a heat treatment at a relatively low temperature for a relatively short time, firing does not sufficiently proceed, and it becomes difficult to obtain a target solid electrolyte having a first crystal phase.

Further, when the solid composition does not contain the above-mentioned oxide, a solid electrolyte that is a lithium-containing composite oxide cannot be formed.

Further, when the solid composition does not contain a lithium compound, a solid electrolyte that is a lithium-containing composite oxide cannot be formed.

Note that in the present disclosure, the “normal temperature and normal pressure” refers to 25° C. and 1 atm.

Further, in the solid composition according to the present disclosure, lithium may be contained, for example, as a constituent element of the oxoacid compound, or may be contained as a constituent element of a component other than the oxide and the oxoacid compound contained in the solid composition. Further, in the solid composition, lithium may be contained as a constituent element of multiple types of components.

### [1-1] Oxide

The solid composition according to the present disclosure contains an oxide having a crystal phase which is different from that of a solid electrolyte to be formed using the solid composition. Hereinafter, the oxide is also referred to as “precursor oxide”. Further, in the present disclosure, the “different” in terms of crystal phase is a broad concept not only including that the type of crystal phase is not the same, but also including that even if the type is the same, at least one lattice constant is different, or the like.

The precursor oxide need only have a second a crystal phase which is different from the crystal phase of a solid electrolyte to be formed using the solid composition according to the present disclosure, that is, a first crystal phase, but, for example, when the crystal phase of a solid electrolyte to be formed using the solid composition according to the present disclosure, that is, the first crystal phase is a cubic garnet-type crystal, the crystal phase of the precursor oxide, that is, the second crystal phase is preferably a pyrochlore-type crystal.

According to this, even when a heat treatment for the solid composition is performed at a lower temperature for a shorter time, a solid electrolyte having a particularly excellent ion conduction property can be favorably obtained.

The second crystal phase of the precursor oxide may be a crystal phase other than the above-mentioned pyrochlore-type crystal, for example, a cubic crystal such as a perovskite structure, a rock salt-type structure, a diamond structure, a fluorite-type structure, or a spinel-type structure, an orthorhombic crystal such as a ramsdellite type, a trigonal crystal such as a corundum type, or the like.

The formulation of the precursor oxide is not particularly limited, however, the precursor oxide is preferably a composite oxide.

In particular, when M is at least one type of element selected from the group consisting of Nb, Ta, and Sb, the precursor oxide is preferably a composite oxide containing La, Zr and M.

According to this, even when a heat treatment for the solid composition is performed at a lower temperature for a shorter time, a solid electrolyte having a particularly excellent ion conduction property can be favorably obtained. In addition, for example, in an all-solid-state secondary battery, the adhesion of a solid electrolyte to be formed to a positive electrode active material or a negative electrode active material can be made more excellent, and a composite material can be formed so as to have a more favorable close contact interface, and thus, the properties and reliability of the all-solid-state secondary battery can be made more excellent.

The M need only be at least one type of element selected from the group consisting of Nb, Ta, and Sb, but is preferably two or more types of elements selected from the group consisting of Nb, Ta, and Sb.

According to this, the above-mentioned effect is more remarkably exhibited.

When the precursor oxide is a composite oxide containing La, Zr and M, it is preferred that the ratio of substance amounts of La, Zr, and M contained in the precursor oxide is 3:2-x:x, and a relationship: 0<x<2.0 is satisfied.

According to this, the above-mentioned effect is more remarkably exhibited.

Further, it is preferred that the precursor oxide does not contain Li.

The precursor oxide, particularly the precursor oxide containing two or more types of metal elements is generally produced through a method for performing a heat treatment.

On the other hand, Li has particularly high volatility among various types of metal elements, and is easily volatilized even in a heating treatment in the process for producing the precursor oxide. Therefore, when the precursor oxide contains Li, it becomes difficult to obtain the precursor oxide having a designed formulation, and as a result, also in a solid electrolyte to be produced using the solid composition according to the present disclosure, it becomes difficult to obtain a designed formulation. However, when the precursor oxide does not contain Li, the occurrence of such a problem can be effectively prevented.

The crystal grain diameter of the precursor oxide is not particularly limited, but is preferably 10 nm or more and 200 nm or less, more preferably 15 nm or more and 180 nm or less, and further more preferably 20 nm or more and 160 nm or less.

According to this, due to a so-called Gibbs-Thomson effect that is a phenomenon of lowering the melting point with an increase in surface energy, the melting temperature of the precursor oxide or the firing temperature for the solid composition can be further lowered. Further, this is also advantageous to the improvement of joining of a solid electrolyte to be formed using the solid composition according to the present disclosure to a heterogeneous material or the reduction of the defect density.

The precursor oxide is preferably constituted by a substantially single crystal phase.

According to this, the precursor oxide undergoes crystal phase transition substantially once when producing a solid electrolyte using the solid composition according to the present disclosure, that is, when generating a high-temperature crystal phase, and therefore, segregation of elements accompanying the crystal phase transition or generation of a contaminant crystal by thermal decomposition is suppressed, so that various properties of a solid electrolyte to be produced are further improved.

In a case where only one exothermic peak is observed within a range of 300° C. or higher and 1,000° C. or lower when measurement is performed by TG-DTA at a temperature raising rate of 10° C./min for the solid composition according to the present disclosure, it can be determined that “it is constituted by a substantially single crystal phase”.

Further, it is preferred that diffraction angles 2θ in an X-ray diffraction pattern of the precursor oxide constituting the solid composition according to the present disclosure are 28.4°, 32.88°, 47.2°, 56.01°, and 58.73°.

When this condition is satisfied, the precursor oxide in which the elements contained in the final composition are more uniformly distributed is obtained, and therefore, the problem that a specific element is deposited at a grain boundary during firing to deteriorate the properties can be more effectively prevented.

The content of the precursor oxide in the solid composition according to the present disclosure is not particularly limited, but is preferably 60 mass % or more and 99.5 mass % or less, and more preferably 70 mass % or more and 99.0 mass % or less.

According to this, even when a heat treatment for the solid composition is performed at a lower temperature for a shorter time, a solid electrolyte having a particularly excellent ion conduction property can be favorably obtained.

The solid composition according to the present disclosure may contain multiple types of precursor oxides. When the solid composition according to the present disclosure contains multiple types of precursor oxides, as the value of the content of the precursor oxide in the solid composition according to the present disclosure, the sum of the contents of the precursor oxides shall be adopted.

### [1-2] Oxoacid Compound

The solid composition according to the present disclosure contains an oxoacid compound.

By containing the oxoacid compound in this manner, the melting point of the precursor oxide is favorably lowered, and the crystal growth of a lithium-containing composite oxide can be promoted, and by a heat treatment at a relatively low temperature for a relatively short time, a solid electrolyte having a desired property can be stably formed. In addition, the adhesion between a solid electrolyte to be formed and an adherend can be made favorable.

The oxoacid compound is a compound containing an oxoanion.

The oxoanion constituting the oxoacid compound does not contain a metal element, and for example, a halogen oxoacid, a borate ion, a carbonate ion, an orthocarbonate ion, a carboxylate ion, a silicate ion, a nitrite ion, a nitrate ion, a phosphite ion, a phosphate ion, an arsenate ion, a sulfite ion, a sulfate ion, a sulfonate ion, a sulfinate ion, and the like are exemplified. As the halogen oxoacid, for example, a hypochlorous ion, a chlorite ion, a chlorate ion, a perchlorate ion, a hypobromite ion, a bromite ion, a bromate ion, a perbromate ion, a hypoiodite ion, an iodite ion, an iodate ion, a periodate ion, and the like are exemplified.

In particular, the oxoacid compound preferably contains, as the oxoanion, at least one of a nitrate ion and a sulfate ion, and more preferably contains a nitrate ion.

According to this, the melting point of the precursor oxide is more favorably lowered, and the crystal growth of a lithium-containing composite oxide can be more effectively promoted. As a result, even when a heat treatment for the solid composition is performed at a lower temperature for a shorter time, a solid electrolyte having a particularly excellent ion conduction property can be favorably obtained.

A cation constituting the oxoacid compound is not particularly limited, and examples thereof include a hydrogen ion, an ammonium ion, a lithium ion, a lanthanum ion, a zirconium ion, a niobium ion, a tantalum ion, and antimony ion, and one type or a combination of two or more types selected from these can be used, however, it is preferably an ion of a constituent metal element of a solid electrolyte to be formed using the solid composition according to the present disclosure.

According to this, an undesirable impurity can be more effectively prevented from remaining in a solid electrolyte to be formed.

The content of the oxoacid compound in the solid composition according to the present disclosure is not particularly limited, but is preferably 0.1 mass % or more and 20 mass % or less, more preferably 1.5 mass % or more and 15 mass % or less, and further more preferably 2.0 mass % or more and 10 mass % or less.

According to this, a solid electrolyte can be favorably obtained from the solid composition according to the present disclosure by a heat treatment at a lower temperature for a shorter time while more reliably preventing the oxoacid compound from undesirably remaining in a solid electrolyte to be formed using the solid composition, and the ion conduction property of the solid electrolyte to be obtained can be made particularly excellent.

When the content of the precursor oxide in the solid composition according to the present disclosure is represented by XP [mass %] and the content of the oxoacid compound in the solid composition according to the present disclosure is represented by XO [mass %], it is preferred to satisfy a relationship: 0.005≤XO/XP≤0.30, it is more preferred to satisfy a relationship: 0.010≤XO/XP≤0.25, and it is further more preferred to satisfy a relationship: 0.012≤XO/XP≤0.19.

According to this, a solid electrolyte can be favorably obtained from the solid composition according to the present disclosure by a heat treatment at a lower temperature for a shorter time while more reliably preventing the oxoacid compound from undesirably remaining in the solid electrolyte to be formed using the solid composition, and the ion conduction property of the solid electrolyte to be obtained can be made particularly excellent.

The solid composition according to the present disclosure may contain multiple types of oxoacid compounds. When the solid composition according to the present disclosure contains multiple types of oxoacid compounds, as the value of the content of the oxoacid compound in the solid composition according to the present disclosure, the sum of the contents of the oxoacid compounds shall be adopted.

### [1-3] Lithium Compound

The solid composition according to the present disclosure contains a lithium compound.

According to this, a solid electrolyte to be formed using the solid composition can be configured to be composed of a lithium-containing composite oxide, and the properties such as ion conductivity can be made excellent.

Examples of the lithium compound contained in the solid composition include inorganic salts such as LiH, LiF, LiCl, LiBr, LiI, LiClO, LiClO₄, LiNO₃, LiNO₂, Li₃N, LiN₃, LiNH₂, Li₂SO₄, Li₂S, LiOH, and Li₂CO₃, carboxylates such as lithium formate, lithium acetate, lithium propionate, lithium 2-ethylhexanoate, and lithium stearate, hydroxy acid salts such as lithium lactate, lithium malate, and lithium citrate, dicarboxylates such as lithium oxalate, lithium malonate, and lithium maleate, alkoxides such as lithium methoxide, lithium ethoxide, lithium propoxide, lithium isopropoxide, lithium butoxide, lithium isobutoxide, lithium sec-butoxide, lithium tert-butoxide, and dipivaloylmethanato lithium, alkylated lithium such as methyl lithium and n-butyl lithium, sulfate esters such as lithium n-butyl sulfate, lithium n-hexyl sulfate, and lithium dodecyl sulfate, diketone complexes such as 2,4-pentanedionato lithium, and hydrates thereof, and derivatives thereof such as a halogen-substituted substance, and one type or a combination of two or more types selected from these can be used.

Above all, the lithium compound is preferably one type or two types selected from the group consisting of lithium carbonate and lithium nitrate.

According to this, the above-mentioned effect is more remarkably exhibited.

When the solid composition contains a compound containing an oxoanion together with a lithium ion, it can be said that the compound is a lithium compound and also is an oxoacid compound.

In addition, when the solid composition contains a precursor oxide having a formulation including Li, it can be said that the precursor oxide is a precursor oxide and also is a lithium compound.

The content of the lithium compound in the solid composition according to the present disclosure is not particularly limited, but is preferably 0.5 mass % or more and 40 mass % or less, and more preferably 1.0 mass % or more and 30 mass % or less.

According to this, even when a heat treatment for the solid composition is performed at a lower temperature for a shorter time, a solid electrolyte having a particularly excellent ion conduction property can be favorably obtained.

When the content of the precursor oxide in the solid composition according to the present disclosure is represented by XP [mass %] and the content of the lithium compound in the solid composition according to the present disclosure is represented by XL [mass %], it is preferred to satisfy a relationship: 0.005≤XL/XP≤0.30, it is more preferred to satisfy a relationship: 0.010≤XL/XP≤0.25, and it is further more preferred to satisfy a relationship: 0.012≤XL/XP≤0.19.

According to this, even when a heat treatment for the solid composition is performed at a lower temperature for a shorter time, a solid electrolyte having a particularly excellent ion conduction property can be favorably obtained.

When the content of the lithium compound in the solid composition according to the present disclosure is represented by XL [mass %] and the content of the oxoacid compound in the solid composition according to the present disclosure is represented by XO [mass %], it is preferred to satisfy a relationship: 0.05≤XO/XL≤2, it is more preferred to satisfy a relationship: 0.08≤XO/XL≤1.25, and it is further more preferred to satisfy a relationship: 0.11≤XO/XL≤1.10.

According to this, a solid electrolyte can be favorably obtained from the solid composition according to the present disclosure by a heat treatment at a lower temperature for a shorter time while more reliably preventing the oxoacid compound from undesirably remaining in the solid electrolyte to be formed using the solid composition, and the ion conduction property of the solid electrolyte to be obtained can be made particularly excellent.

The solid composition according to the present disclosure may contain multiple types of lithium compounds. When the solid composition according to the present disclosure contains multiple types of lithium compounds, as the value of the content of the lithium compound in the solid composition according to the present disclosure, the sum of the contents of the lithium compounds shall be adopted.

### [1-4] Another Component

The solid composition according to the present disclosure contains the precursor oxide, the oxoacid compound, and the lithium compound as described above, but may further contain a component other than these. Hereinafter, among the components constituting the solid composition according to the present disclosure, a component other than the precursor oxide, the lithium compound, and the oxoacid compound is referred to as “another component”.

As such another component contained in the solid composition according to the present disclosure, for example, an oxide having the same crystal phase as that of a solid electrolyte to be produced using the solid composition according to the present disclosure, a solvent component used in the process for producing the solid composition according to the present disclosure, or the like is exemplified.

The content of such another component in the solid composition according to the present disclosure is not particularly limited, but is preferably 10 mass % or less, more preferably 5.0 mass % or less, and further more preferably 0.5 mass % or less.

The solid composition according to the present disclosure may contain multiple types of components as such another component. In that case, as the value of the content of another component in the solid composition according to the present disclosure, the sum of the contents of the components shall be adopted.

When M is at least one type of element selected from the group consisting of Nb, Ta, and Sb, it is preferred that the solid composition contains Li, La, Zr, and M. In particular, it is preferred that the ratio of substance amounts of Li, La, Zr, and M contained in the solid composition according to the present disclosure is 7-x:3:2-x:x, and a relationship: 0<x<2.0 is satisfied.

According to this, the ion conduction property of a solid electrolyte to be formed using the solid composition according to the present disclosure can be made more excellent.

Here, x satisfies the condition: 0<x<2.0, but preferably satisfies a condition: 0.01<x<1.75, more preferably satisfies a condition: 0.1<x<1.25, and further more preferably satisfies a condition: 0.2<x<1.0.

According to this, the above-mentioned effect is more remarkably exhibited.

The solid composition according to the present disclosure need only be in a solid form as a whole, and may contain a liquid component such as a liquid component used in, for example, the production process thereof. However, in that case, the content of the liquid component in the solid composition is preferably 5 mass % or less, and more preferably 1 mass % or less.

### [2] Method for Producing Solid Composition

Next, a method for producing a solid composition according to the present disclosure will be described.

The method for producing a solid composition according to the present disclosure is a method for producing a solid composition to be used for forming a solid electrolyte having a first crystal phase, and includes a precursor oxide production step that is a step of producing an oxide constituted by a second crystal phase which is different from the first crystal phase at normal temperature and normal pressure, that is, a precursor oxide, and an oxoacid compound mixing step that is a step of mixing the precursor oxide with an oxoacid compound.

According to this, a method for producing a solid composition capable of favorably producing a solid composition enabling stable formation of a solid electrolyte having a desired property by a heat treatment at a relatively low temperature for a relatively short time can be provided.

More specifically, by a method as described above, a solid composition containing an oxide constituted by a second crystal phase which is different from the first crystal phase at normal temperature and normal pressure, and an oxoacid compound can be favorably produced. The solid composition obtained in this manner enables stable formation of a solid electrolyte having a desired property by a heat treatment at a relatively low temperature for a relatively short time. That is, by containing an oxoacid compound in the solid composition, the melting point of the oxide is lowered, and a close contact interface with an adherend can be formed while promoting the crystal growth in a firing treatment that is a heat treatment at a relatively low temperature for a relatively short time. Further, due to an action capable of causing a reaction of incorporating lithium ions in the oxide contained in the solid composition during the reaction, a solid electrolyte that is a lithium-containing composite oxide can be formed at a low temperature. Therefore, for example, a decrease in the ion conductivity due to volatilization of lithium ions that has been a problem in the related art can be suppressed, and an effect of being able to produce an all-solid-state battery having excellent battery capacity at a high load is obtained.

Hereinafter, the respective steps will be described in detail.

### [2-1] Precursor Oxide Production Step

In the precursor oxide production step, a precursor oxide that is an oxide constituted by a crystal phase (that is, a second crystal phase) which is different from the crystal phase of a solid electrolyte to be finally obtained, that is, the first crystal phase at normal temperature and normal pressure is produced.

The precursor oxide may be produced by any method, however, in this embodiment, the precursor oxide production step includes a metal compound solution preparation step of preparing a metal compound solution containing a metal compound including a metal element constituting the precursor oxide in a molecule and a solvent, a first heat treatment step of subjecting the metal compound solution to a first heat treatment, and a second heat treatment step of subjecting a composition obtained by the first heat treatment to a second heat treatment at a higher temperature than in the first heat treatment.

### [2-1-1] Metal Compound Solution Preparation Step

In the metal compound solution preparation step, a metal compound solution containing a metal compound including a metal element constituting the precursor oxide in a molecule and a solvent is prepared.

When the precursor oxide contains multiple types of metal elements, for example, the metal compound solution can be prepared by preparing solutions for each of the metal compounds corresponding to the respective metal elements, and mixing the resulting solutions. More specifically, for example, when the precursor oxide contains La, Zr, and the M as metal elements, in the preparation of the metal compound solution, a solution containing La, a solution containing Zr, and a solution containing M may be used.

Further, for example, the metal compound solution may be prepared by dissolving multiple types of metal compounds corresponding to two or more types of metal elements constituting the precursor oxide in the same solvent.

Further, for example, in the preparation of the metal compound solution, a metal compound containing two or more types of metal elements constituting the precursor oxide in a molecule may be used.

Further, two or more types of metal compounds may be used for the same metal element.

When the precursor oxide contains multiple types of metal elements, in this step, it is preferred that these respective metal elements are mixed at a ratio stoichiometrically corresponding to the formulation of a solid electrolyte to be finally formed. Note that in place of the solution, a dispersion liquid may be used.

In this step, a lithium compound may be used as the metal compound, but it is preferred that a lithium compound is not used in this step.

Lithium is a highly volatile component among various types of metals. Therefore, by not using a lithium compound in this step, undesirable volatilization of lithium in a heat treatment step as described below, particularly the second heat treatment step can be prevented, and the solid composition or the solid electrolyte to be finally obtained can be more reliably made to have a desired formulation.

Further, in the preparation of the metal compound solution, for example, in addition to the metal compound, an oxoacid compound may be used. Further, a compound containing an oxoanion may be used as the metal compound.

As the metal compound containing a metal element constituting the precursor oxide in a molecule, for example, compounds as follows can be used.

That is, as a lanthanum compound that is a metal compound as a lanthanum source, for example, a lanthanum metal salt, a lanthanum alkoxide, lanthanum hydroxide, and the like are exemplified, and it is possible to use one type or two or more types in combination among these. Examples of the lanthanum metal salt include lanthanum chloride, lanthanum nitrate, lanthanum sulfate, lanthanum acetate, and tris(2,4-pentanedionato)lanthanum. Examples of the lanthanum alkoxide include lanthanum trimethoxide, lanthanum triethoxide, lanthanum tripropoxide, lanthanum triisopropoxide, lanthanum tributoxide, lanthanum triisobutoxide, lanthanum tri-sec-butoxide, lanthanum tri-tert-butoxide, and dipivaloylmethanato lanthanum. Above all, the lanthanum compound is preferably at least one type selected from the group consisting of lanthanum nitrate, tris(2,4-pentanedionato)lanthanum, and lanthanum hydroxide. As the lanthanum source, a hydrate may be used.

As a zirconium compound that is a metal compound as a zirconium source, for example, a zirconium metal salt, a zirconium alkoxide, and the like are exemplified, and it is possible to use one type or two or more types in combination among these. Examples of the zirconium metal salt include zirconium chloride, zirconium oxychloride, oxyacetate, and zirconium acetate. Examples of the zirconium alkoxide include zirconium tetramethoxide, zirconium tetraethoxide, zirconium tetrapropoxide, zirconium tetraisopropoxide, zirconium tetrabutoxide, zirconium tetraisobutoxide, zirconium tetra-sec-butoxide, zirconium tetra-tert-butoxide, and dipivaloylmethanato zirconium. Above all, as the zirconium compound, zirconium tetrabutoxide is preferred. As the zirconium source, a hydrate may be used.

As a niobium compound that is a metal compound as a niobium source, for example, a niobium metal salt, a niobium alkoxide, niobium acetylacetone, and the like are exemplified, and it is possible to use one type or two or more types in combination among these. Examples of the niobium metal salt include niobium chloride, niobium oxychloride, and niobium oxalate. Examples of the niobium alkoxide include niobium ethoxide such as niobium pentaethoxide, niobium propoxide, niobium isopropoxide, and niobium sec-butoxide. Above all, as the niobium compound, niobium pentaethoxide is preferred. As the niobium source, a hydrate may be used.

As a tantalum compound that is a metal compound as a tantalum source, for example, a tantalum metal salt, a tantalum alkoxide, and the like are exemplified, and it is possible to use one type or two or more types in combination among these. Examples of the tantalum metal salt include tantalum chloride and tantalum bromide. Examples of the tantalum alkoxide include tantalum pentamethoxide, tantalum pentaethoxide, tantalum pentaisopropoxide, tantalum penta-n-propoxide, tantalum pentaisobutoxide, tantalum penta-n-butoxide, tantalum penta-sec-butoxide, and tantalum penta-tert-butoxide. Above all, as the tantalum compound, tantalum pentaethoxide is preferred. As the tantalum source, a hydrate may be used.

As an antimony compound that is a metal compound as an antimony source, for example, an antimony metal salt, an antimony alkoxide, and the like are exemplified, and it is possible to use one type or two or more types in combination among these. Examples of the antimony metal salt include antimony bromide, antimony chloride, and antimony fluoride. Examples of the antimony alkoxide include antimony trimethoxide, antimony triethoxide, antimony triisopropoxide, antimony tri-n-propoxide, antimony tributoxide, and antimony tri-n-butoxide. Above all, as the antimony compound, antimony tributoxide is preferred. As the antimony source, a hydrate may be used.

The solvent is not particularly limited, and for example, various types of organic solvents can be used, however, more specifically, for example, an alcohol, a glycol, a ketone, an ester, an ether, an organic acid, an aromatic, an amide, and the like are exemplified, and one type or a mixed solvent that is a combination of two or more types selected from these can be used. Examples of the alcohol include methyl alcohol, ethyl alcohol, n-propyl alcohol, isopropyl alcohol, n-butyl alcohol, allyl alcohol, and 2-n-butoxyethanol. Examples of the glycol include ethylene glycol, propylene glycol, butylene glycol, hexylene glycol, pentanediol, hexanediol, heptanediol, and dipropylene glycol. Examples of the ketone include dimethyl ketone, methyl ethyl ketone, methyl propyl ketone, and methyl isobutyl ketone. Examples of the ester include methyl formate, ethyl formate, methyl acetate, and methyl acetoacetate. Examples of the ether include diethylene glycol monomethyl ether, diethylene glycol monoethyl ether, diethylene glycol dimethyl ether, ethylene glycol monomethyl ether, ethylene glycol monoethyl ether, and dipropylene glycol monomethyl ether. Examples of the organic acid include formic acid, acetic acid, 2-ethylbutyric acid, and propionic acid. Examples of the aromatic include toluene, o-xylene, and p-xylene. Examples of the amide include formamide, N,N-dimethylformamide, N,N-diethylformamide, dimethylacetamide, and N-methylpyrrolidone. Above all, the solvent is preferably at least one of 2-n-butoxyethanol and propionic acid.

### [2-1-2] First Heat Treatment Step

The metal compound solution prepared as described above is subjected to a first heat treatment. By doing this, the metal compound solution is generally gelled.

The conditions of the first heat treatment depend on the boiling point or the vapor pressure of the solvent or the like, but the heating temperature in the first heat treatment is preferably 50° C. or higher and 250° C. or lower, more preferably 60° C. or higher and 230° C. or lower, and further more preferably 80° C. or higher and 200° C. or lower. During the first heat treatment, the heating temperature may be changed. For example, the first heat treatment may include a first stage in which a heat treatment is performed while maintaining a relatively low temperature, and a second stage in which the temperature is raised after the first stage, and a heat treatment at a relatively high temperature is performed. In such a case, it is preferred that the highest temperature in the first heat treatment falls within the above-mentioned range.

Further, the heating time in the first heat treatment is preferably 10 minutes or more and 180 minutes or less, more preferably 20 minutes or more and 120 minutes or less, and further more preferably 30 minutes or more and 60 minutes or less.

The first heat treatment may be performed in any atmosphere, and may be performed in an oxidizing atmosphere such as in the air or in an oxygen gas atmosphere, or may be performed in a non-oxidizing atmosphere of an inert gas such as nitrogen gas, helium gas, or argon gas, or the like. Further, the first heat treatment may be performed under reduced pressure or vacuum, or under pressure.

Further, during the first heat treatment, the atmosphere may be maintained under substantially the same conditions, or may be changed to different conditions. For example, the first heat treatment may include a first stage in which a heat treatment is performed in a normal pressure environment and a second stage in which a heat treatment is performed in a reduced pressure environment after the first stage.

### [2-1-3] Second Heat Treatment Step

Thereafter, the composition obtained by the first heat treatment, for example, the composition in a gel form is subjected to a second heat treatment.

By doing this, the precursor oxide is obtained.

Although the conditions of the second heat treatment depend on the formulation of the oxide to be formed or the like, the heating temperature in the second heat treatment need only be higher than the treatment temperature in the first heat treatment, and is preferably 400° C. or higher and 600° C. or lower, more preferably 430° C. or higher and 570° C. or lower, and further more preferably 450° C. or higher and 550° C. or lower. During the second heat treatment, the heating temperature may be changed. For example, the second heat treatment may include a first stage in which a heat treatment is performed while maintaining a relatively low temperature, and a second stage in which the temperature is raised after the first stage, and a heat treatment is performed at a relatively high temperature. In such a case, it is preferred that the highest temperature in the second heat treatment falls within the above-mentioned range.

Further, the heating time in the second heat treatment is preferably 5 minutes or more and 180 minutes or less, more preferably 10 minutes or more and 120 minutes or less, and further more preferably 15 minutes or more and 60 minutes or less.

The second heat treatment may be performed in any atmosphere, and may be performed in an oxidizing atmosphere such as in the air or in an oxygen gas atmosphere, or may be performed in a non-oxidizing atmosphere of an inert gas such as nitrogen gas, helium gas, or argon gas, or the like. Further, the second heat treatment may be performed under reduced pressure or vacuum, or under pressure. In particular, the second heat treatment is preferably performed in an oxidizing atmosphere.

Further, during the second heat treatment, the atmosphere may be maintained under substantially the same conditions, or may be changed to different conditions. For example, the second heat treatment may include a first stage in which a heat treatment is performed in an inert gas atmosphere and a second stage in which a heat treatment is performed in an oxidizing atmosphere after the first stage.

### [2-2] Oxoacid Compound Mixing Step

In the oxoacid compound mixing step, the precursor oxide obtained in the precursor oxide production step and an oxoacid compound are mixed.

By doing this, the solid composition according to the present disclosure containing the precursor oxide and the oxoacid compound is obtained.

As the oxoacid compound, for example, a compound described in the above [1-2] can be used. According to this, the same effect as described above is obtained.

In particular, it is preferred to use, as the oxoacid compound, a lithium compound that is also an oxoacid compound among the lithium compounds described in the above [1-3], and it is more preferred to use lithium nitrate.

According to this, it becomes easy to obtain a crystal with better quality even by a heat treatment at a low temperature.

In this step, another component may be used other than the precursor oxide and the oxoacid compound.

As such a component, for example, a lithium compound other than a lithium oxoacid salt, that is, a lithium compound that is not an oxoacid compound, or the like is exemplified.

Further, the mixing of the precursor oxide with the oxoacid compound may be performed by a dry process or a wet process. When the mixing is performed by a wet process, a step of removing a liquid component contained in the system may be performed after the mixing.

In the solid composition obtained in this manner, generally, almost all the liquid component such as a solvent used in the production process is removed, however, a portion of the liquid component may remain. However, the content of the liquid component in the solid composition is preferably 1.0 mass % or less, and more preferably 0.1 mass % or less. Even if a small amount of a liquid component is contained in this manner, such a composition is in a solid form as a whole.

The solid composition according to the present disclosure obtained as described above is converted into a solid electrolyte by heating as described in detail later, particularly, by heating at a higher temperature than in the above-mentioned second heat treatment.

Therefore, when the heat treatment for obtaining a solid electrolyte from the solid composition according to the present disclosure is regarded as main firing, the heat treatment for obtaining the precursor oxide, particularly the above-mentioned second heat treatment can be referred to as calcination. Further, when the solid electrolyte obtained by a heat treatment which will be described in detail later is regarded as a main fired body, the precursor oxide can be referred to as a calcined body.

### [3] Method for Producing Solid Electrolyte

Next, a method for producing a solid electrolyte according to the present disclosure will be described.

The method for producing a solid electrolyte according to the present disclosure includes a step of producing a solid composition by the above-mentioned method for producing a solid composition according to the present disclosure, and a heating step of heating the solid composition at a temperature of 700° C. or higher and 1000° C. or lower.

According to this, a method for producing a solid electrolyte enabling stable formation of a solid electrolyte having a desired property by a heat treatment at a relatively low temperature for a relatively short time can be provided. More specifically, by containing an oxoacid compound in the solid composition, the melting point of the oxide is lowered, and a close contact interface with an adherend can be formed while promoting the crystal growth in a firing treatment that is a heat treatment at a relatively low temperature for a relatively short time. Further, due to an action capable of causing a reaction of incorporating lithium ions in the oxide contained in the solid composition during the reaction, a solid electrolyte that is a lithium-containing composite oxide can be formed at a low temperature. Therefore, for example, a decrease in the ion conductivity due to volatilization of lithium ions that has been a problem in the related art can be suppressed, and an effect of being able to produce an all-solid-state battery having excellent battery capacity at a high load is obtained. Further, since a solid electrolyte can be produced by a heat treatment at a relatively low temperature for a relatively short time, for example, the productivity of the solid electrolyte or an all-solid-state battery including the solid electrolyte can be made more excellent, and also from the viewpoint of energy saving, such a heat treatment is preferred. In addition, according to the method for producing a solid electrolyte according to the present disclosure, there is an advantage that the above-mentioned effect can be obtained regardless of the formulation of the solid composition, particularly the formulation or crystal type of the precursor oxide, or the like.

In the method for producing a solid electrolyte according to the present disclosure, multiple types of solid compositions according to the present disclosure may be used in combination.

The heating temperature in the heating step in the method for producing a solid electrolyte according to the present disclosure need only be 700° C. or higher and 1000° C. or lower as described above, but is preferably 730° C. or higher and 980° C. or lower, more preferably 750° C. or higher and 950° C. or lower, and further more preferably 780° C. or higher and 930° C. or lower.

According to this, the above-mentioned effect is more remarkably exhibited.

During the heating step in the method for producing a solid electrolyte according to the present disclosure, the heating temperature may be changed. For example, the heating step in the method for producing a solid electrolyte according to the present disclosure may include a first stage in which a heat treatment is performed while maintaining a relatively low temperature, and a second stage in which the temperature is raised after the first stage, and a heat treatment at a relatively high temperature is performed. In such a case, it is preferred that the highest temperature in the heating step falls within the above-mentioned range.

The heating time in the heating step in the method for producing a solid electrolyte according to the present disclosure is not particularly limited, but is preferably 5 minutes or more and 300 minutes or less, more preferably 10 minutes or more and 120 minutes or less, and further more preferably 15 minutes or more and 60 minutes or less.

According to this, the above-mentioned effect is more remarkably exhibited.

The heating step may be performed in any atmosphere, and may be performed in an oxidizing atmosphere such as in the air or in an oxygen gas atmosphere, or may be performed in a non-oxidizing atmosphere of an inert gas such as nitrogen gas, helium gas, or argon gas, or the like. Further, the heating step may be performed under reduced pressure or vacuum, or under pressure. In particular, the heating step is preferably performed in an oxidizing atmosphere.

Further, during the heating step, the atmosphere may be maintained under substantially the same conditions, or may be changed to different conditions.

According to the method for producing a solid electrolyte according to the present disclosure, a target solid electrolyte, in particular, a high quality solid electrolyte can be obtained by a heat treatment at a relatively low temperature as described above, however, the present disclosure does not exclude also performing a heat treatment at a higher temperature, in particular, a heat treatment at a higher temperature for a relatively short time in addition to the heat treatment in the temperature range as described above.

Further, in the method for producing a solid electrolyte according to the present disclosure, the solid composition according to the present disclosure may be subjected to the heating step as described above in a state of being mixed with another component. For example, the solid composition according to the present disclosure may be subjected to the heating step in a state of being mixed with an active material such as a positive electrode active material or a negative electrode active material.

The method for producing a solid electrolyte according to the present disclosure may include a step other than the above-mentioned heating step.

The solid electrolyte obtained using the method for producing a solid electrolyte according to the present disclosure generally does not substantially contain the oxoacid compound contained in the solid composition according to the present disclosure used as a raw material. More specifically, the content of the oxoacid compound in the solid electrolyte obtained using the method for producing a solid electrolyte according to the present disclosure is generally 100 ppm or less, and particularly, it is preferably 50 ppm or less, and more preferably 10 ppm or less.

According to this, the content of an undesirable impurity in the solid electrolyte can be suppressed, and the properties and reliability of the solid electrolyte can be made more excellent.

The crystal phase of the solid electrolyte, that is, the first crystal phase is preferably a cubic garnet-type crystal, but may be a crystal phase other than a cubic garnet-type crystal, for example, a tetragonal garnet-type crystal or the like.

### [4] Secondary Battery

Next, a secondary battery to which the present disclosure is applied will be described.

A secondary battery according to the present disclosure is produced using the solid composition according to the present disclosure as described above, and can be produced by, for example, applying the method for producing a solid electrolyte according to the present disclosure described above.

Such a secondary battery has excellent charge-discharge characteristics.

### [4-1] Secondary Battery of First Embodiment

Hereinafter, a secondary battery according to a first embodiment will be described.

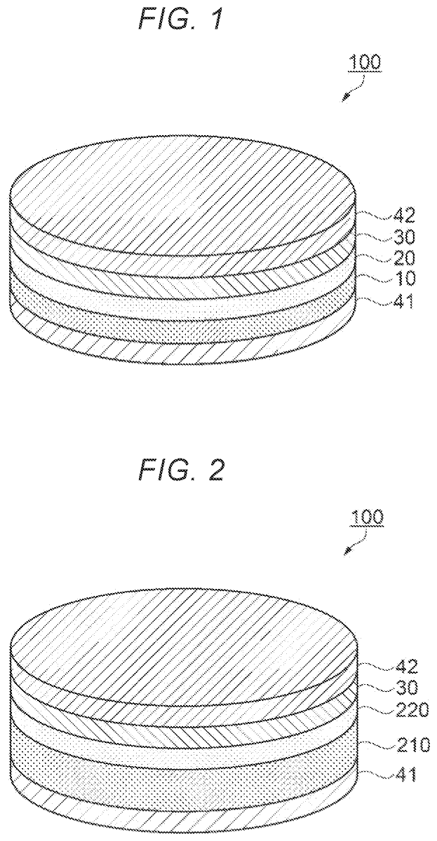

FIG. 1 is a schematic perspective view schematically showing a configuration of a lithium-ion battery as the secondary battery of the first embodiment.

As shown in FIG. 1, a lithium-ion battery 100 as the secondary battery includes a positive electrode 10, and a solid electrolyte layer 20 and a negative electrode 30, which are sequentially stacked on the positive electrode 10. The lithium-ion battery further includes a current collector 41 in contact with the positive electrode 10 at an opposite face side of the positive electrode 10 from a face thereof facing the solid electrolyte layer 20, and includes a current collector 42 in contact with the negative electrode 30 at an opposite face side of the negative electrode 30 from a face thereof facing the solid electrolyte layer 20. The positive electrode 10, the solid electrolyte layer 20, and the negative electrode 30 are all constituted by a solid phase, and therefore, the lithium-ion battery 100 is a chargeable and dischargeable all solid-state secondary battery.

The shape of the lithium-ion battery 100 is not particularly limited, and may be, for example, a polygonal disk shape or the like, but is a circular disk shape in the configuration shown in the drawing. The size of the lithium-ion battery 100 is not particularly limited, but for example, the diameter of the lithium-ion battery 100 is, for example, 10 mm or more and 20 mm or less, and the thickness of the lithium-ion battery 100 is, for example, 0.1 mm or more and 1.0 mm or less.

When the lithium-ion battery 100 is small and thin in this manner, together with the fact that it is chargeable and dischargeable and is an all solid-state battery, it can be favorably used as a power supply of a portable information terminal such as a smartphone. The lithium-ion battery 100 may be used for a purpose other than the power supply of a portable information terminal as described later.

Hereinafter, the respective configurations of the lithium-ion battery 100 will be described.

### [4-1-1] Solid Electrolyte Layer

The solid electrolyte layer 20 is formed using the solid composition according to the present disclosure described above.

According to this, the ion conductivity of the solid electrolyte layer 20 becomes excellent. Further, the adhesion of the solid electrolyte layer 20 to the positive electrode 10 or the negative electrode 30 can be made excellent. As a result, the properties and reliability of the lithium-ion battery 100 as a whole can be made particularly excellent.

The thickness of the solid electrolyte layer 20 is not particularly limited, but is preferably 0.3 μm or more and 1000 μm or less, and more preferably 0.5 μm or more and 100 μm or less from the viewpoint of charge-discharge rate.

Further, from the viewpoint of preventing a short circuit between the positive electrode 10 and the negative electrode 30 due to a lithium dendritic crystal body deposited at the negative electrode 30 side, a value obtained by dividing the measured weight of the solid electrolyte layer 20 by a value obtained by multiplying the apparent volume of the solid electrolyte layer 20 by the theoretical density of the solid electrolyte material, that is, the sintered density is preferably set to 50% or more, and more preferably set to 90% or more.

As a method for forming the solid electrolyte layer 20, for example, a green sheet method, a press firing method, a cast firing method, or the like is exemplified. A specific example of the method for forming the solid electrolyte layer 20 will be described in detail later. For the purpose of improving the adhesion of the solid electrolyte layer 20 to the positive electrode 10 and the negative electrode 30, or improving the output or battery capacity of the lithium-ion battery 100 by an increase in specific surface area, or the like, for example, a three-dimensional pattern structure such as a dimple, trench, or pillar pattern may be formed at a surface of the solid electrolyte layer 20 to come in contact with the positive electrode 10 or the negative electrode 30.

### [4-1-2] Positive Electrode

The positive electrode 10 may be any as long as it is constituted by a positive electrode active material that can repeat electrochemical occlusion and release of lithium ions.

Specifically, as the positive electrode active material constituting the positive electrode 10, for example, a lithium composite oxide which contains at least Li and is constituted by any one or more types of elements selected from the group consisting of V, Cr, Mn, Fe, Co, Ni, and Cu, or the like can be used. Examples of such a composite oxide include LiCoO₂, LiNiO₂, LiMn₂O₄, Li₂Mn₂O₃, LiCr_{0.5}Mn_{0.5}O₂, LiFePO₄, Li₂FeP₂O₇, LiMnPO₄, LiFeBO₃, Li₃V₂ (PO₄)₃, Li₂CuO₂, Li₂FeSiO₄, and Li₂MnSiO₄. Further, as the positive electrode active material constituting the positive electrode 10, for example, a fluoride such as LiFeF₃, a boride complex compound such as LiBH₄ or Li₄BN₃H₁₀, an iodine complex compound such as a polyvinylpyridine-iodine complex, a nonmetallic compound such as sulfur, or the like can also be used.

The positive electrode 10 is preferably formed as a thin film at one surface of the solid electrolyte layer 20 in consideration of an electric conduction property and an ion diffusion distance.

The thickness of the positive electrode 10 formed of the thin film is not particularly limited, but is preferably 0.1 μm or more and 500 μm or less, and more preferably 0.3 μm or more and 100 μm or less.

As a method for forming the positive electrode 10, for example, a vapor phase deposition method such as a vacuum vapor deposition method, a sputtering method, a CVD method, a PLD method, an ALD method, or an aerosol deposition method, a chemical deposition method using a solution such as a sol-gel method or an MOD method, or the like is exemplified. In addition, for example, fine particles of the positive electrode active material are formed into a slurry together with an appropriate binder, followed by squeegeeing or screen printing, thereby forming a coating film, and then, the coating film may be baked onto the surface of the solid electrolyte layer 20 by drying and firing.

### [4-1-3] Negative Electrode

The negative electrode 30 may be any as long as it is constituted by a so-called negative electrode active material that repeats electrochemical occlusion and release of lithium ions at a lower potential than the material selected as the positive electrode 10.

Specifically, examples of the negative electrode active material constituting the negative electrode 30 include Nb₂O₅, V₂O₅, TiO₂, In₂O₃, ZnO, SnO₂, NiO, ITO, AZO, GZO, ATO, FTO, and lithium composite oxides such as Li₄Ti₅O₁₂ and Li₂Ti₃O₇. Further, additional examples thereof include metals and alloys such as Li, Al, Si, Si—Mn, Si—Co, Si—Ni, Sn, Zn, Sb, Bi, In, and Au, carbon materials, and materials obtained by intercalation of lithium ions between layers of a carbon material such as LiC₂₄ and LiC₆.

The negative electrode 30 is preferably formed as a thin film at one surface of the solid electrolyte layer 20 in consideration of an electric conduction property and an ion diffusion distance.

The thickness of the negative electrode 30 formed of the thin film is not particularly limited, but is preferably 0.1 μm or more and 500 μm or less, and more preferably 0.3 μm or more and 100 μm or less.

As a method for forming the negative electrode 30, for example, a vapor phase deposition method such as a vacuum vapor deposition method, a sputtering method, a CVD method, a PLD method, an ALD method, or an aerosol deposition method, a chemical deposition method using a solution such as a sol-gel method or an MOD method, or the like is exemplified. In addition, for example, fine particles of the negative electrode active material are formed into a slurry together with an appropriate binder, followed by squeegeeing or screen printing, thereby forming a coating film, and then, the coating film may be baked onto the surface of the solid electrolyte layer 20 by drying and firing.

### [4-1-4] Current Collector

The current collectors 41 and 42 are electric conductors provided so as to play a role in transfer of electrons to the positive electrode 10 or the negative electrode 30. As the current collector, generally, a current collector constituted by a material that has a sufficiently small electrical resistance, and that does not substantially change the electric conduction property or the mechanical structure thereof by charging and discharging is used. Specifically, as the constituent material of the current collector 41 of the positive electrode 10, for example, Al, Ti, Pt, Au, or the like is used. Further, as the constituent material of the current collector 42 of the negative electrode 30, for example, Cu or the like is favorably used.

The current collectors 41 and 42 are generally provided so that the contact resistance with the positive electrode 10 and the negative electrode 30 becomes small, respectively. Examples of the shape of each of the current collectors 41 and 42 include a plate shape and a mesh shape.

The thickness of each of the current collectors 41 and 42 is not particularly limited, but is preferably 7 μm or more and 85 μm or less, and more preferably 10 μm or more and 60 μm or less.

In the configuration shown in the drawing, the lithium-ion battery 100 includes a pair of current collectors 41 and 42, however, for example, when a plurality of lithium-ion batteries 100 are used by being stacked and electrically coupled to one another in series, the lithium-ion battery 100 may also be configured to include only the current collector 41 of the current collectors 41 and 42.

The lithium-ion battery 100 may be used for any purpose. Examples of an electronic device to which the lithium-ion battery 100 is applied as a power supply include a personal computer, a digital camera, a cellular phone, a smartphone, a music player, a tablet terminal, a timepiece, a smartwatch, various types of printers such as an inkjet printer, a television, a projector, wearable terminals such as a head-up display, wireless headphones, wireless earphones, smart glasses, and a head-mounted display, a video camera, a videotape recorder, a car navigation device, a drive recorder, a pager, an electronic notebook, an electronic dictionary, an electronic translation machine, an electronic calculator, an electronic gaming device, a toy, a word processor, a work station, a robot, a television telephone, a television monitor for crime prevention, electronic binoculars, a POS terminal, a medical device, a fish finder, various types of measurement devices, a device for mobile terminal base stations, various types of meters for vehicles, railroad cars, airplanes, helicopters, ships, or the like, a flight simulator, and a network server. Further, the lithium-ion battery 100 may be applied to, for example, moving objects such as a car and a ship. More specifically, it can be favorably applied as, for example, a storage battery for electric cars, plug-in hybrid cars, hybrid cars, fuel cell cars, or the like. In addition, it can also be applied to, for example, a power supply for household use, a power supply for industrial use, a storage battery for photovoltaic power generation, or the like.

### [4-2] Secondary Battery of Second Embodiment

Next, a secondary battery according to a second embodiment will be described.

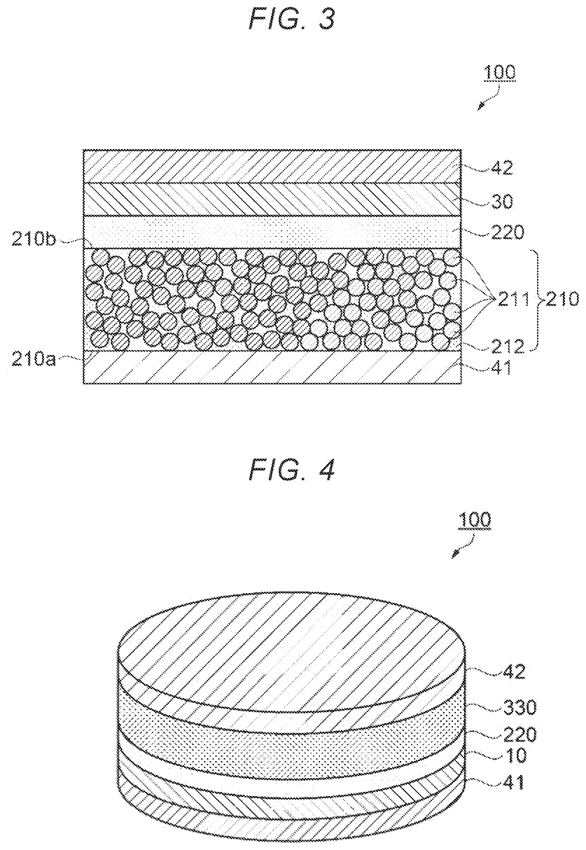

FIG. 2 is a schematic perspective view schematically showing a configuration of a lithium-ion battery as the secondary battery of the second embodiment, and FIG. 3 is a schematic cross-sectional view schematically showing a structure of the lithium-ion battery as the secondary battery of the second embodiment.

Hereinafter, the secondary battery according to the second embodiment will be described with reference to these drawings, but different points from the above-mentioned embodiment will be mainly described, and the description of the same matter will be omitted.

As shown in FIG. 2, a lithium-ion battery 100 as the secondary battery of this embodiment includes a positive electrode composite material 210 that functions as a positive electrode, and an electrolyte layer 220 and a negative electrode 30, which are sequentially stacked on the positive electrode composite material 210. The lithium-ion battery further includes a current collector 41 in contact with the positive electrode composite material 210 at an opposite face side of the positive electrode composite material 210 from a face thereof facing the electrolyte layer 220, and includes a current collector 42 in contact with the negative electrode 30 at an opposite face side of the negative electrode 30 from a face thereof facing the electrolyte layer 220.

Hereinafter, the positive electrode composite material 210 and the electrolyte layer 220 which are different from the configuration of the lithium-ion battery 100 according to the above-mentioned embodiment will be described.

### [4-2-1] Positive Electrode Composite Material

As shown in FIG. 3, the positive electrode composite material 210 in the lithium-ion battery 100 of this embodiment includes a positive electrode active material 211 in a particulate shape and a solid electrolyte 212. In such a positive electrode composite material 210, the battery reaction rate in the lithium-ion battery 100 can be further increased by increasing an interfacial area where the positive electrode active material 211 in a particulate shape and the solid electrolyte 212 are in contact with each other.

The average particle diameter of the positive electrode active material 211 is not particularly limited, but is preferably 0.1 μm or more and 150 μm or less, and more preferably 0.3 μm or more and 60 μm or less.

According to this, it becomes easy to achieve both an actual capacity density close to the theoretical capacity of the positive electrode active material 211 and a high charge-discharge rate.

Note that in this specification, the average particle diameter refers to a volume-based average particle diameter, and can be determined by, for example, subjecting a dispersion liquid prepared by adding a sample to methanol and dispersing the sample for 3 minutes using an ultrasonic disperser to measurement with a particle size distribution analyzer according to the Coulter counter method (model TA-II, manufactured by Coulter Electronics, Inc.) using an aperture of 50 μm.

The particle size distribution of the positive electrode active material 211 is not particularly limited, and for example, in the particle size distribution having one peak, the half width of the peak can be set to 0.15 μm or more and 19 μm or less. Further, the particle size distribution of the positive electrode active material 211 may have two or more peaks.

In FIG. 3, the shape of the positive electrode active material 211 in a particulate shape is shown as a spherical shape, however, the shape of the positive electrode active material 211 is not limited to the spherical shape, and it can have various shapes, for example, a columnar shape, a plate shape, a scaly shape, a hollow shape, an indefinite shape, and the like, and further, two or more types among these may be mixed.

Examples of the positive electrode active material 211 include the same materials as exemplified as the constituent material of the positive electrode 10 in the above-mentioned first embodiment.

In the positive electrode active material 211, for example, a coating layer may be formed at a surface for the purpose of reducing the interface resistance between the positive electrode active material 211 and the solid electrolyte 212, or improving an electron conduction property, or the like. For example, by forming a thin film of LiNbO₃, Al₂O₃, ZrO₂, Ta₂O₅, or the like at a surface of a particle of the positive electrode active material 211 composed of LiCoO₂, the interface resistance of lithium ion conduction can be further reduced. The thickness of the coating layer is not particularly limited, but is preferably 3 nm or more and 1 μm or less.

In this embodiment, the positive electrode composite material 210 includes the solid electrolyte 212 in addition to the positive electrode active material 211 described above. The solid electrolyte 212 is present so as to fill up a gap between particles of the positive electrode active material 211 or so as to be in contact with, particularly in close contact with the surface of the positive electrode active material 211.

The solid electrolyte 212 is formed using the solid composition according to the present disclosure described above.

According to this, the ion conductivity of the solid electrolyte 212 becomes particularly excellent. Further, the adhesion of the solid electrolyte 212 to the positive electrode active material 211 or the electrolyte layer 220 becomes excellent. Accordingly, the properties and reliability of the lithium-ion battery 100 as a whole can be made particularly excellent.

When the content of the positive electrode active material 211 in the positive electrode composite material 210 is represented by XA [mass %] and the content of the solid electrolyte 212 in the positive electrode composite material 210 is represented by XS [mass %], it is preferred to satisfy a relationship: 0.1≤XS/XA≤8.3, it is more preferred to satisfy a relationship: 0.3≤XS/XA≤2.8, and it is further more preferred to satisfy a relationship: 0.6≤XS/XA≤1.4.

Further, the positive electrode composite material 210 may include an electric conduction assistant, a binder, or the like other than the positive electrode active material 211 and the solid electrolyte 212.

As the electric conduction assistant, any material may be used as long as it is an electric conductor whose electrochemical interaction can be ignored at a positive electrode reaction potential, and more specifically, for example, a carbon material such as acetylene black, Ketjen black, or a carbon nanotube, a noble metal such as palladium or platinum, an electric conductive oxide such as SnO₂, ZnO, RuO₂, ReO₃, or Ir₂O₃, or the like can be used.

The thickness of the positive electrode composite material 210 is not particularly limited, but is preferably 0.1 μm or more and 500 μm or less, and more preferably 0.3 μm or more and 100 μm or less.

### [4-2-2] Electrolyte Layer

The electrolyte layer 220 is preferably constituted by the same material or the same type of material as the solid electrolyte 212 from the viewpoint of an interfacial impedance between the electrolyte layer 220 and the positive electrode composite material 210, but may be constituted by a material different from the solid electrolyte 212. For example, the electrolyte layer 220 is formed using the solid composition according to the present disclosure described above, but may be constituted by a material having a different formulation from the solid electrolyte 212. Further, the electrolyte layer 220 may be a crystalline material or an amorphous material of another oxide solid electrolyte which is not formed using the solid composition according to the present disclosure, a sulfide solid electrolyte, a nitride solid electrolyte, a halide solid electrolyte, a hydride solid electrolyte, a dry polymer electrolyte, or a quasi-solid electrolyte, or may be constituted by a material in which two or more types selected from these are combined.

Examples of a crystalline oxide include Li_{0.35}La_{0.55}TiO₃, Li_{0.2}La_{0.27}NbO₃, and a perovskite-type crystal or a perovskite-like crystal in which the elements constituting a crystal thereof are partially substituted with N, F, Al, Sr, Sc, Nb, Ta, Sb, a lanthanoid element, or the like, Li₇La₃Zr₂O₁₂, Li₅La₃Nb₂O₁₂, Li₅BaLa₂TaO₁₂, and a garnet-type crystal or a garnet-like crystal in which the elements constituting a crystal thereof are partially substituted with N, F, Al, Sr, Sc, Nb, Ta, Sb, a lanthanoid element, or the like, Li_{1.3}Ti_{1.7}Al_{0.3}(PO₄)₃, Li_{1.4}Al_{0.4}Ti_{1.6} (PO₄)₃, Li_{1.4}Al_{0.4}Ti_{1.4}Ge_{0.2}(PO₄)₃, and a NASICON-type crystal in which the elements constituting a crystal thereof are partially substituted with N, F, Al, Sr, Sc, Nb, Ta, Sb, a lanthanoid element, or the like, a LISICON-type crystal such as Li₁₄ZnGe₄O₁₆, and other crystalline materials such as Li_{3.4}V_{0.6}Si_{0.4}O₄, Li_{3.6}V_{0.4}Ge_{0.6}O₄, and Li₂₊ₓC₁₋ₓBₓO₃.

Examples of a crystalline sulfide include Li₁₀GeP₂S₁₂, Li_{9.6}P₃S₁₂, Li_{9.54}Si_{1.74}P_{1.44}S_{11.7}Cl_{0.3}, and Li₃PS₄.

Examples of other amorphous materials include Li₂O—TiO₂, La₂O₃—Li₂O—TiO₂, LiNbO₃, LiSO₄, Li₄SiO₄, Li₃PO₄—Li₄SiO₄, Li₄GeO₄—Li₃VO₄, Li₄SiO₄—Li₃VO₄, Li₄GeO₄—Zn₂GeO₂, Li₄SiO₄—LiMoO₄, Li₄SiO₄—Li₄ZrO₄, SiO₂—P₂O₅—Li₂O, SiO₂—P₂O₅—LiCl, Li₂O—LiCl—B₂O₃, LiAlCl₄, LiAlF₄, LiF—Al₂O₃, LiBr—Al₂O₃, Li_{2.88}P_{03.73}N_{0.14}, Li₃N—LiCl, Li₆NBr₃, Li₂S—SiS₂, and Li₂S—SiS₂—P₂S₅.

When the electrolyte layer 220 is constituted by a crystalline material, the crystalline material preferably has a crystal structure such as a cubic crystal having small crystal plane anisotropy in the direction of lithium ion conduction. Further, when the electrolyte layer 220 is constituted by an amorphous material, the anisotropy in lithium ion conduction becomes small. Therefore, the crystalline material and the amorphous material as described above are both preferred as a solid electrolyte constituting the electrolyte layer 220.

The thickness of the electrolyte layer 220 is preferably 0.1 μm or more and 100 μm or less, and more preferably 0.2 μm or more and 10 μm or less. When the thickness of the electrolyte layer 220 is a value within the above range, the internal resistance of the electrolyte layer 220 can be further decreased, and also the occurrence of a short circuit between the positive electrode composite material 210 and the negative electrode 30 can be more effectively prevented.

For the purpose of improving the adhesion between the electrolyte layer 220 and the negative electrode 30, or improving the output or battery capacity of the lithium-ion battery 100 by an increase in specific surface area, or the like, for example, a three-dimensional pattern structure such as a dimple, trench, or pillar pattern may be formed at a surface of the electrolyte layer 220 to come in contact with the negative electrode 30.

### [4-3] Secondary Battery of Third Embodiment

Next, a secondary battery according to a third embodiment will be described.

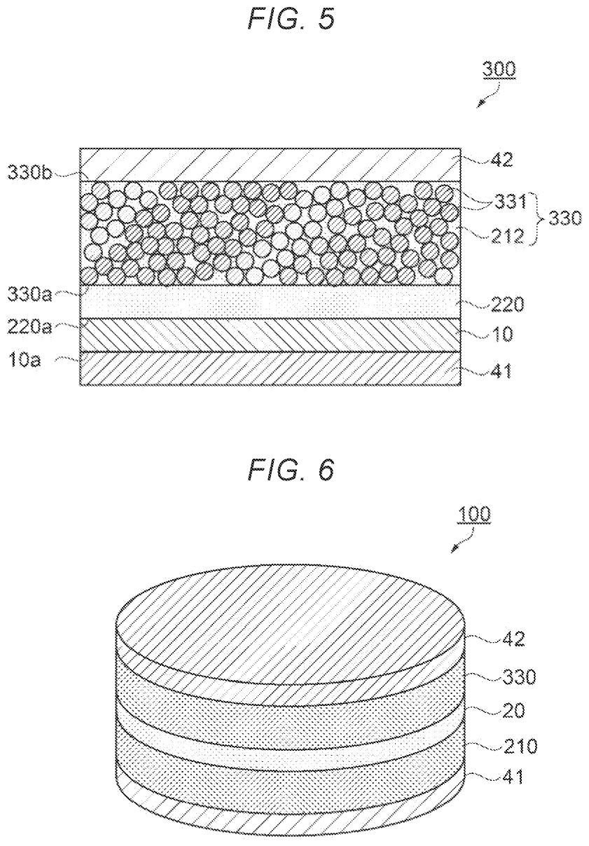

FIG. 4 is a schematic perspective view schematically showing a configuration of a lithium-ion battery as the secondary battery of the third embodiment, and FIG. 5 is a schematic cross-sectional view schematically showing a structure of the lithium-ion battery as the secondary battery of the third embodiment.

Hereinafter, the secondary battery according to the third embodiment will be described with reference to these drawings, but different points from the above-mentioned embodiments will be mainly described, and the description of the same matter will be omitted.

As shown in FIG. 4, a lithium-ion battery 100 as the secondary battery of this embodiment includes a positive electrode 10, and an electrolyte layer 220 and a negative electrode composite material 330 that functions as a negative electrode, which are sequentially stacked on the positive electrode 10. The lithium-ion battery further includes a current collector 41 in contact with the positive electrode 10 at an opposite face side of the positive electrode 10 from a face thereof facing the electrolyte layer 220, and includes a current collector 42 in contact with the negative electrode composite material 330 at an opposite face side of the negative electrode composite material 330 from a face thereof facing the electrolyte layer 220.

Hereinafter, the negative electrode composite material 330 which is different from the configuration of the lithium-ion battery 100 according to the above-mentioned embodiments will be described.

### [4-3-1] Negative Electrode Composite Material

As shown in FIG. 5, the negative electrode composite material 330 in the lithium-ion battery 100 of this embodiment includes a negative electrode active material 331 in a particulate shape and a solid electrolyte 212. In such a negative electrode composite material 330, the battery reaction rate in the lithium-ion battery 100 can be further increased by increasing an interfacial area where the negative electrode active material 331 in a particulate shape and the solid electrolyte 212 are in contact with each other.

The average particle diameter of the negative electrode active material 331 is not particularly limited, but is preferably 0.1 μm or more and 150 μm or less, and more preferably 0.3 μm or more and 60 μm or less.

According to this, it becomes easy to achieve both an actual capacity density close to the theoretical capacity of the negative electrode active material 331 and a high charge-discharge rate.

The particle size distribution of the negative electrode active material 331 is not particularly limited, and for example, in the particle size distribution having one peak, the half width of the peak can be set to 0.1 μm or more and 18 μm or less. Further, the particle size distribution of the negative electrode active material 331 may have two or more peaks.

In FIG. 5, the shape of the negative electrode active material 331 in a particulate shape is shown as a spherical shape, however, the shape of the negative electrode active material 331 is not limited to the spherical shape, and it can have various shapes, for example, a columnar shape, a plate shape, a scaly shape, a hollow shape, an indefinite shape, and the like, and further, two or more types among these may be mixed.

Examples of the negative electrode active material 331 include the same materials as exemplified as the constituent material of the negative electrode 30 in the above-mentioned first embodiment.

In this embodiment, the negative electrode composite material 330 includes the solid electrolyte 212 in addition to the negative electrode active material 331 described above. The solid electrolyte 212 is present so as to fill up a gap between particles of the negative electrode active material 331 or so as to be in contact with, particularly in close contact with the surface of the negative electrode active material 331.

The solid electrolyte 212 is formed using the solid composition according to the present disclosure described above.

According to this, the ion conductivity of the solid electrolyte 212 becomes particularly excellent. Further, the adhesion of the solid electrolyte 212 to the negative electrode active material 331 or the electrolyte layer 220 can be made excellent. Accordingly, the properties and reliability of the lithium-ion battery 100 as a whole can be made particularly excellent.

When the content of the negative electrode active material 331 in the negative electrode composite material 330 is represented by XB [mass %] and the content of the solid electrolyte 212 in the negative electrode composite material 330 is represented by XS [mass %], it is preferred to satisfy a relationship: 0.14≤XS/XB≤26, it is more preferred to satisfy a relationship: 0.44≤XS/XB≤4.1, and it is further more preferred to satisfy a relationship: 0.89≤XS/XB≤2.1.

Further, the negative electrode composite material 330 may include an electric conduction assistant, a binder, or the like other than the negative electrode active material 331 and the solid electrolyte 212.

As the electric conduction assistant, any material may be used as long as it is an electric conductor whose electrochemical interaction can be ignored at a negative electrode reaction potential, and more specifically, for example, a carbon material such as acetylene black, Ketjen black, or a carbon nanotube, a noble metal such as palladium or platinum, an electric conductive oxide such as SnO₂, ZnO, RuO₂, ReO₃, or Ir₂O₃, or the like can be used.

The thickness of the negative electrode composite material 330 is not particularly limited, but is preferably 0.1 μm or more and 500 μm or less, and more preferably 0.3 μm or more and 100 μm or less.

### [4-4] Secondary Battery of Fourth Embodiment

Next, a secondary battery according to a fourth embodiment will be described.

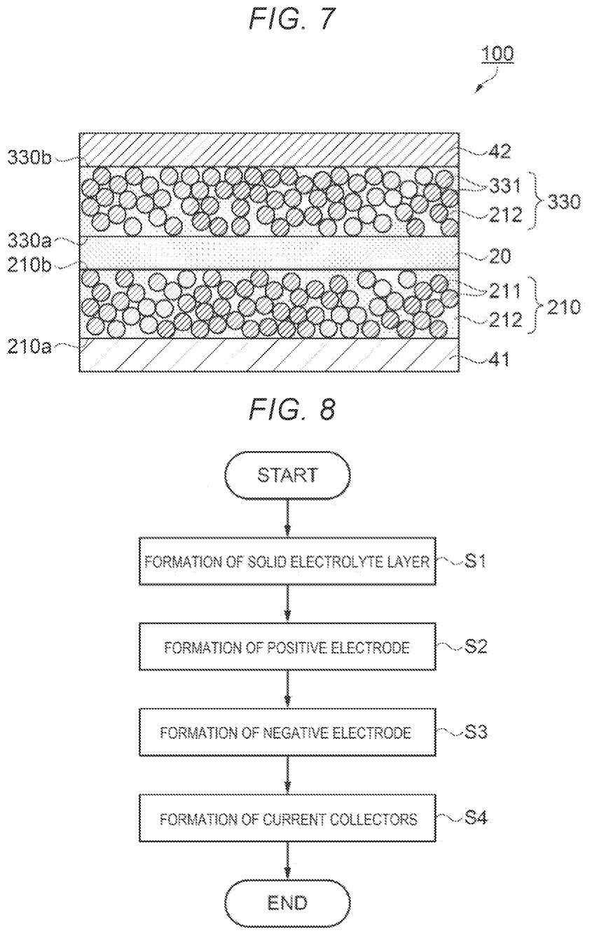

FIG. 6 is a schematic perspective view schematically showing a configuration of a lithium-ion battery as the secondary battery of the fourth embodiment, and FIG. 7 is a schematic cross-sectional view schematically showing a structure of the lithium-ion battery as the secondary battery of the fourth embodiment.

Hereinafter, the secondary battery according to the fourth embodiment will be described with reference to these drawings, but different points from the above-mentioned embodiments will be mainly described, and the description of the same matter will be omitted.

As shown in FIG. 6, a lithium-ion battery 100 as the secondary battery of this embodiment includes a positive electrode composite material 210, and a solid electrolyte layer 20 and a negative electrode composite material 330, which are sequentially stacked on the positive electrode composite material 210. The lithium-ion battery further includes a current collector 41 in contact with the positive electrode composite material 210 at an opposite face side of the positive electrode composite material 210 from a face thereof facing the solid electrolyte layer 20, and includes a current collector 42 in contact with the negative electrode composite material 330 at an opposite face side of the negative electrode composite material 330 from a face thereof facing the solid electrolyte layer 20.

It is preferred that the respective portions satisfy the same conditions as described for the respective portions corresponding thereto in the above-mentioned embodiments.

In the first to fourth embodiments, another layer may be provided between layers or at a surface of a layer of the respective layers constituting the lithium-ion battery 100. Examples of such a layer include an adhesive layer, an insulating layer, and a protective layer.

### [5] Method for Producing Secondary Battery

Next, a method for producing the above-mentioned secondary battery will be described.

### [5-1] Method for Producing Secondary Battery of First Embodiment

Hereinafter, a method for producing the secondary battery according to the first embodiment will be described.

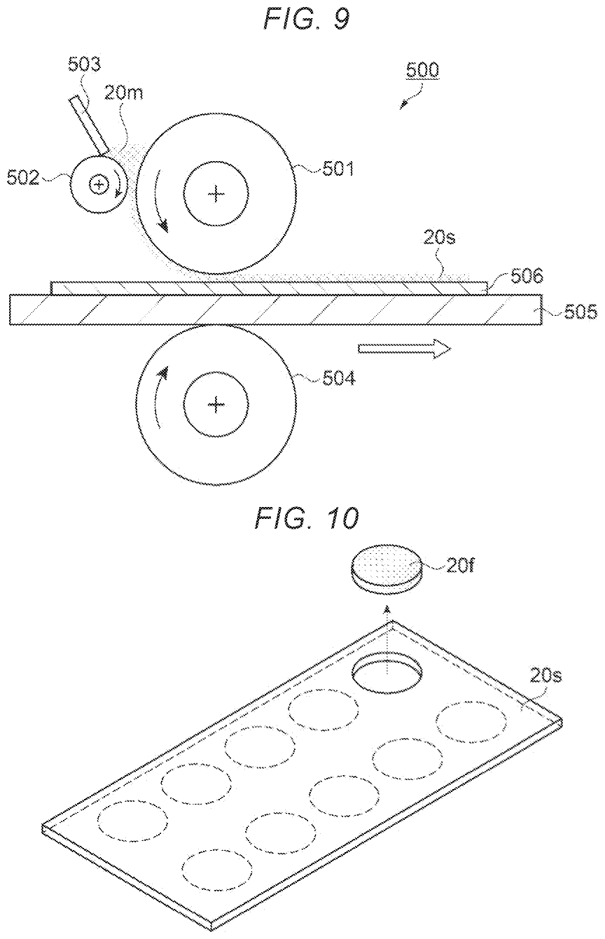

FIG. 8 is a flowchart showing the method for producing the lithium-ion battery as the secondary battery of the first embodiment, FIGS. 9 and 10 are schematic views schematically showing the method for producing the lithium-ion battery as the secondary battery of the first embodiment, and FIG. 11 is a schematic cross-sectional view schematically showing another method for forming a solid electrolyte layer.

As shown in FIG. 8, the method for producing the lithium-ion battery 100 of this embodiment includes Step S1, Step S2, Step S3, and Step S4.

Step S1 is a step of forming the solid electrolyte layer 20. Step S2 is a step of forming the positive electrode 10. Step S3 is a step of forming the negative electrode 30. Step S4 is a step of forming the current collectors 41 and 42.

### [5-1-1] Step S1

In the step of forming the solid electrolyte layer 20 of Step S1, the solid electrolyte layer 20 is formed by, for example, a green sheet method using the solid composition according to the present disclosure. More specifically, the solid electrolyte layer 20 can be formed as follows.

That is, first, for example, a solution in which a binder such as polypropylene carbonate is dissolved in a solvent such as 1,4-dioxane is prepared, and the solution and the solid composition according to the present disclosure are mixed, whereby a slurry 20m is obtained. In the preparation of the slurry 20m, a dispersant, a diluent, a humectant, or the like may be further used as needed.

Subsequently, by using the slurry 20m, a solid electrolyte forming sheet 20s is formed. More specifically, as shown in FIG. 9, for example, by using a fully automatic film applicator 500, the slurry 20m is applied to a predetermined thickness onto a base material 506 such as a polyethylene terephthalate film, whereby the solid electrolyte forming sheet 20s is formed. The fully automatic film applicator 500 includes an application roller 501 and a doctor roller 502. A squeegee 503 is provided so as to come in contact with the doctor roller 502 from above. A conveyance roller 504 is provided below the application roller 501 at a position opposite thereto, and a stage 505 on which the base material 506 is placed is conveyed in a fixed direction by inserting the stage 505 between the application roller 501 and the conveyance roller 504. The slurry 20m is fed to a side where the squeegee 503 is provided between the application roller 501 and the doctor roller 502 disposed with a gap therebetween in the conveyance direction of the stage 505. The slurry 20m with a predetermined thickness is applied to the surface of the application roller 501 by rotating the application roller 501 and the doctor roller 502 so as to extrude the slurry 20m downward from the gap. Then, along with this, by rotating the conveyance roller 504, the stage 505 is conveyed so that the base material 506 comes in contact with the application roller 501 to which the slurry 20m has been applied. By doing this, the slurry 20m applied to the application roller 501 is transferred in a sheet form to the base material 506, whereby the solid electrolyte forming sheet 20s is formed.

Thereafter, the solvent is removed from the solid electrolyte forming sheet 20s formed on the base material 506, and the solid electrolyte forming sheet 20s is detached from the base material 506 and punched to a predetermined size using a punching die as shown in FIG. 10, whereby a molded material 20f is formed.

Thereafter, the molded material 20f is subjected to a heating step at a temperature of 700° C. or higher and 1000° C. or lower, whereby the solid electrolyte layer 20 as a main fired body is obtained. The heating time and atmosphere in the heating step are as described above.

The solid electrolyte forming sheet 20s with a predetermined thickness may be formed by pressing and extruding the slurry 20m by the application roller 501 and the doctor roller 502 so that the sintered density of the solid electrolyte layer 20 after firing becomes 90% or more.

### [5-1-2] Step S2

After Step S1, the process proceeds to Step S2.

In the step of forming the positive electrode 10 of Step S2, the positive electrode 10 is formed at one face of the solid electrolyte layer 20. More specifically, for example, first, by using a sputtering device, sputtering is performed using LiCoO₂ as a target in an inert gas such as argon gas, whereby a LiCoO₂ layer is formed at a surface of the solid electrolyte layer 20. Thereafter, the LiCoO₂ layer formed on the solid electrolyte layer 20 is fired in an oxidizing atmosphere so as to convert the crystal of the LiCoO₂ layer into a high-temperature phase crystal, whereby the LiCoO₂ layer can be converted into the positive electrode 10. The firing conditions for the LiCoO₂ layer are not particularly limited, but the heating temperature can be set to 400° C. or higher and 600° C. or lower, and the heating time can be set to 1 hour or more and 3 hours or less.

### [5-1-3] Step S3

After Step S2, the process proceeds to Step S3.

In the step of forming the negative electrode 30 of Step S3, the negative electrode 30 is formed at the other face of the solid electrolyte layer 20, that is, a face at an opposite side from the face at which the positive electrode 10 is formed. More specifically, for example, by using a vacuum deposition device or the like, the negative electrode 30 can be formed by forming a thin film of metal Li at a face of the solid electrolyte layer 20 at an opposite side from the face at which the positive electrode 10 is formed. The thickness of the negative electrode 30 can be set to, for example, 0.1 μm or more and 500 μm or less.

### [5-1-4] Step S4

After Step S3, the process proceeds to Step S4.

In the step of forming the current collectors 41 and 42 of Step S4, the current collector 41 is formed so as to come in contact with the positive electrode 10, and the current collector 42 is formed so as to come in contact with the negative electrode 30. More specifically, for example, an aluminum foil formed into a circular shape by punching or the like is joined to the positive electrode 10 by pressing, whereby the current collector 41 can be formed. Further, for example, a copper foil formed into a circular shape by punching or the like is joined to the negative electrode 30 by pressing, whereby the current collector 42 can be formed. The thickness of each of the current collectors 41 and 42 is not particularly limited, but can be set to, for example, 10 μm or more and 60 μm or less. In this step, only one of the current collectors 41 and 42 may be formed.

The method for forming the solid electrolyte layer 20 is not limited to the green sheet method shown in Step S1. As another method for forming the solid electrolyte layer 20, for example, a method as described below can be adopted. That is, as shown in FIG. 11, the molded material 20f may be obtained by filling the solid composition according to the present disclosure in a powder form in a pellet die 80, closing the pellet die using a lid 81, and pressing the lid 81 to perform uniaxial press molding. A treatment for the molded material 20f thereafter can be performed in the same manner as described above. As the pellet die 80, a die including an exhaust port (not shown) can be favorably used.

### [5-2] Method for Producing Secondary Battery of Second Embodiment

Next, a method for producing the secondary battery according to the second embodiment will be described.

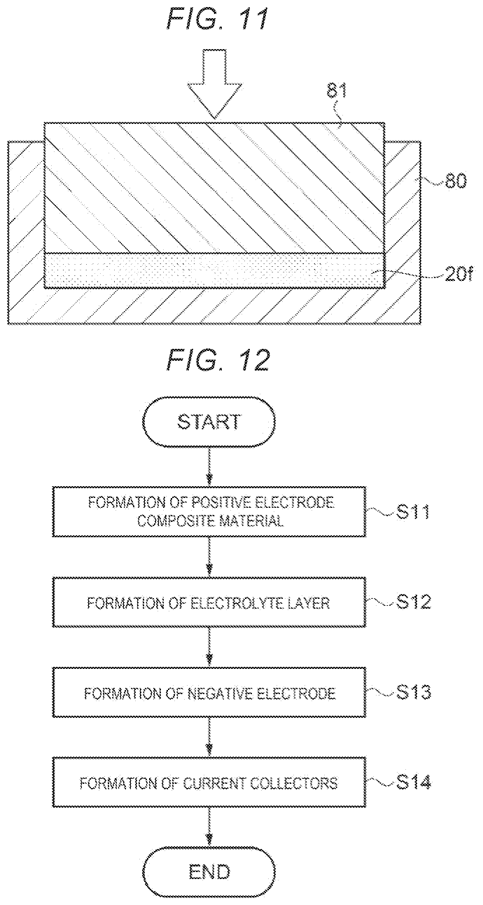

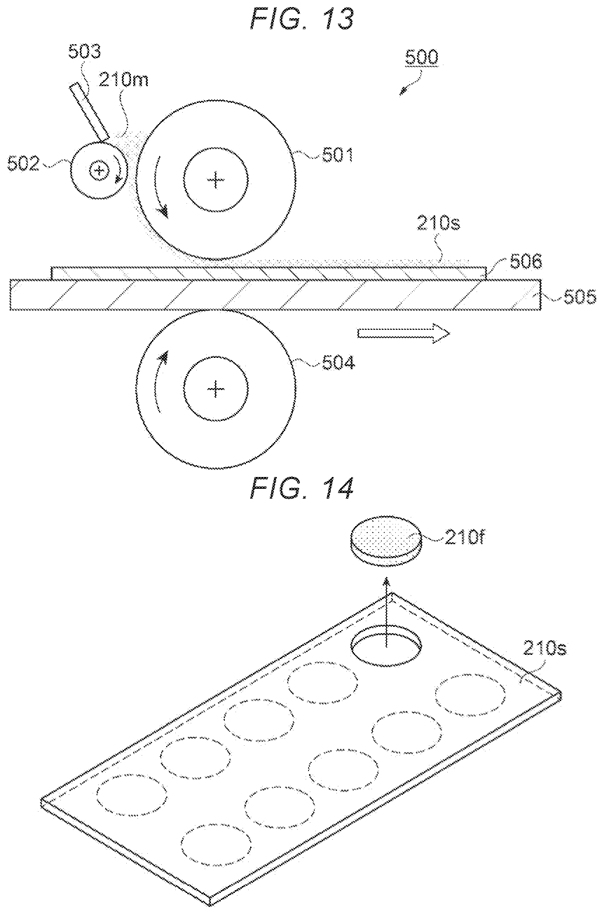

FIG. 12 is a flowchart showing the method for producing the lithium-ion battery as the secondary battery of the second embodiment, and FIGS. 13 and 14 are schematic views schematically showing the method for producing the lithium-ion battery as the secondary battery of the second embodiment.

Hereinafter, the method for producing the secondary battery according to the second embodiment will be described with reference to these drawings, but different points from the above-mentioned embodiment will be mainly described, and the description of the same matter will be omitted.

As shown in FIG. 12, the method for producing the lithium-ion battery 100 of this embodiment includes Step S11, Step S12, Step S13, and Step S14.

Step S11 is a step of forming the positive electrode composite material 210. Step S12 is a step of forming the electrolyte layer 220. Step S13 is a step of forming the negative electrode 30. Step S14 is a step of forming the current collectors 41 and 42.

### [5-2-1] Step S11

In the step of forming the positive electrode composite material 210 of Step S11, the positive electrode composite material 210 is formed.

The positive electrode composite material 210 can be formed, for example, as follows.

That is, first, for example, a slurry 210m as a mixture of the positive electrode active material 211 such as LiCoO₂, the solid composition according to the present disclosure, a binder such as polypropylene carbonate, and a solvent such as 1,4-dioxane is obtained. In the preparation of the slurry 210m, a dispersant, a diluent, a humectant, or the like may be further used as needed.

Subsequently, by using the slurry 210m, a positive electrode composite material forming sheet 210s is formed. More specifically, as shown in FIG. 13, for example, by using a fully automatic film applicator 500, the slurry 210m is applied to a predetermined thickness onto a base material 506 such as a polyethylene terephthalate film, whereby the positive electrode composite material forming sheet 210s is formed.

Thereafter, the solvent is removed from the positive electrode composite material forming sheet 210s formed on the base material 506, and the positive electrode composite material forming sheet 210s is detached from the base material 506 and punched to a predetermined size using a punching die as shown in FIG. 14, whereby a molded material 210f is formed.

Thereafter, the molded material 210f is subjected to a heating step at a temperature of 700° C. or higher and 1000° C. or lower, whereby the positive electrode composite material 210 including a solid electrolyte is obtained. The heating time and atmosphere in the heating step are as described above.

### [5-2-2] Step S12

After Step S11, the process proceeds to Step S12.

In the step of forming the electrolyte layer 220 of Step S12, the electrolyte layer 220 is formed at one face 210b of the positive electrode composite material 210. More specifically, for example, by using a sputtering device, sputtering is performed using LiCoO₂ as a target in an inert gas such as argon gas, whereby a LiCoO₂ layer is formed at a surface of the positive electrode composite material 210. Thereafter, the LiCoO₂ layer formed on the positive electrode composite material 210 is fired in an oxidizing atmosphere so as to convert the crystal of the LiCoO₂ layer into a high-temperature phase crystal, whereby the LiCoO₂ layer can be converted into the electrolyte layer 220. The firing conditions for the LiCoO₂ layer are not particularly limited, but the heating temperature can be set to 400° C. or higher and 600° C. or lower, and the heating time can be set to 1 hour or more and 3 hours or less.

### [5-2-3] Step S13

After Step S12, the process proceeds to Step S13.

In the step of forming the negative electrode 30 of Step S13, the negative electrode 30 is formed at an opposite face side of the electrolyte layer 220 from a face thereof facing the positive electrode composite material 210. More specifically, for example, by using a vacuum deposition device or the like, the negative electrode 30 can be formed by forming a thin film of metal Li at an opposite face side of the electrolyte layer 220 from a face thereof facing the positive electrode composite material 210.

### [5-2-4] Step S14

After Step S13, the process proceeds to Step S14.

In the step of forming the current collectors 41 and 42 of Step S14, the current collector 41 is formed so as to come in contact with the other face of the positive electrode composite material 210, that is, a face 210a at an opposite side from the face 210b at which the electrolyte layer 220 is formed, and the current collector 42 is formed so as to come in contact with the negative electrode 30.

The methods for forming the positive electrode composite material 210 and the electrolyte layer 220 are not limited to the above-mentioned methods. For example, the positive electrode composite material 210 and the electrolyte layer 220 may be formed as follows. That is, first, a slurry as a mixture of the solid composition according to the present disclosure, a binder, and a solvent is obtained. Then, the obtained slurry is fed to a fully automatic film applicator 500 and applied onto the base material 506, whereby an electrolyte forming sheet is formed. Thereafter, the electrolyte forming sheet and the positive electrode composite material forming sheet 210s formed in the same manner as described above are pressed in a stacked state and bonded to each other. Thereafter, a stacked sheet obtained by bonding the sheets to each other is punched to form a molded material, and the molded material is fired in an oxidizing atmosphere, whereby a stacked body of the positive electrode composite material 210 and the electrolyte layer 220 may be obtained.

### [5-3] Method for Producing Secondary Battery of Third Embodiment

Next, a method for producing the secondary battery according to the third embodiment will be described.

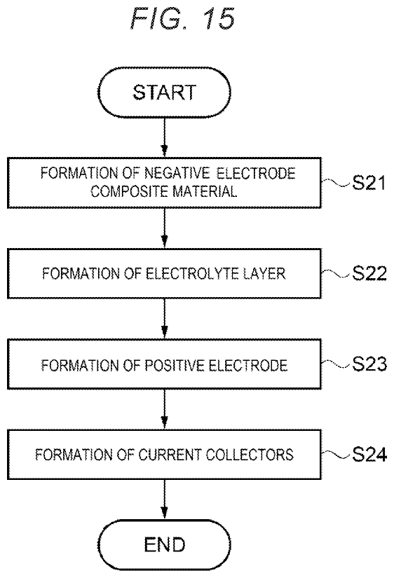

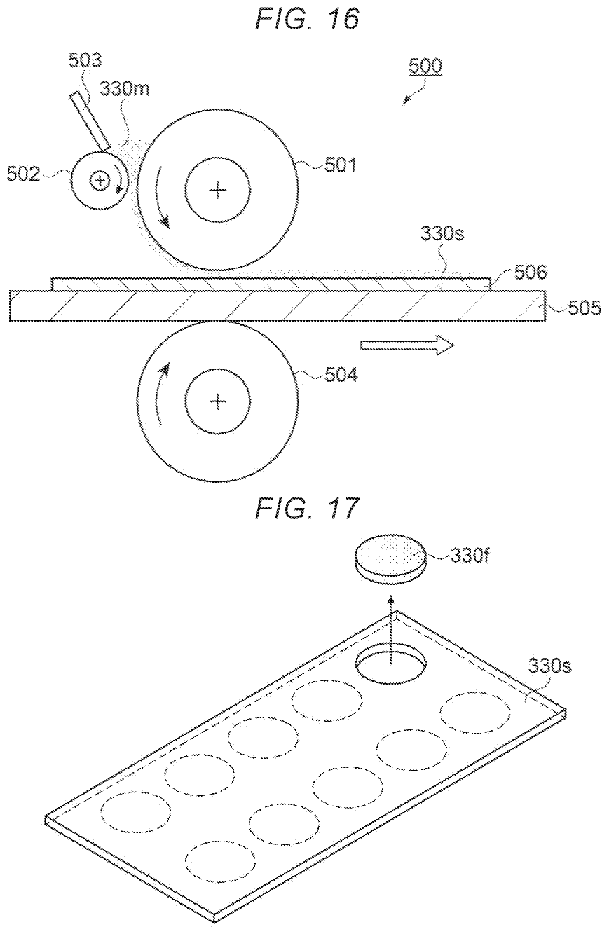

FIG. 15 is a flowchart showing the method for producing the lithium-ion battery as the secondary battery of the third embodiment, and FIGS. 16 and 17 are schematic views schematically showing the method for producing the lithium-ion battery as the secondary battery of the third embodiment.

Hereinafter, the method for producing the secondary battery according to the third embodiment will be described with reference to these drawings, but different points from the above-mentioned embodiments will be mainly described, and the description of the same matter will be omitted.

As shown in FIG. 15, the method for producing the lithium-ion battery 100 of this embodiment includes Step S21, Step S22, Step S23, and Step S24.

Step S21 is a step of forming the negative electrode composite material 330. Step S22 is a step of forming the electrolyte layer 220. Step S23 is a step of forming the positive electrode 10. Step S24 is a step of forming the current collectors 41 and 42.

### [5-3-1] Step S21

In the step of forming the negative electrode composite material 330 of Step S21, the negative electrode composite material 330 is formed.

The negative electrode composite material 330 can be formed, for example, as follows.

That is, first, for example, a slurry 330m as a mixture of the negative electrode active material 331 such as Li₄Ti₅O₁₂, the solid composition according to the present disclosure, a binder such as polypropylene carbonate, and a solvent such as 1,4-dioxane is obtained. In the preparation of the slurry 330m, a dispersant, a diluent, a humectant, or the like may be further used as needed.

Subsequently, by using the slurry 330m, a negative electrode composite material forming sheet 330s is formed. More specifically, as shown in FIG. 16, for example, by using a fully automatic film applicator 500, the slurry 330m is applied to a predetermined thickness onto a base material 506 such as a polyethylene terephthalate film, whereby the negative electrode composite material forming sheet 330s is formed.

Thereafter, the solvent is removed from the negative electrode composite material forming sheet 330s formed on the base material 506, and the negative electrode composite material forming sheet 330s is detached from the base material 506 and punched to a predetermined size using a punching die as shown in FIG. 17, whereby a molded material 330f is formed.

Thereafter, the molded material 330f is subjected to a heating step at a temperature of 700° C. or higher and 1000° C. or lower, whereby the negative electrode composite material 330 including a solid electrolyte is obtained. The heating time and atmosphere in the heating step are as described above.

### [5-3-2] Step S22

After Step S21, the process proceeds to Step S22.

In the step of forming the electrolyte layer 220 of Step S22, the electrolyte layer 220 is formed at one face 330a of the negative electrode composite material 330. More specifically, for example, by using a sputtering device, sputtering is performed using Li_{2.2}C_{0.8}B_{0.2}O₃ which is a solid solution of Li₂CO₃ and Li₃BO₃ as a target in an inert gas such as argon gas, whereby a Li_{2.2}C_{0.8}B_{0.2}O₃ layer is formed at a surface of the negative electrode composite material 330. Thereafter, the Li_{2.2}C_{0.8}B_{0.2}O₃ layer formed on the negative electrode composite material 330 is fired in an oxidizing atmosphere so as to convert the crystal of the Li_{2.2}C_{0.3}B_{0.2}O₃ layer into a high-temperature phase crystal, whereby the Li_{2.2}C_{0.8}B_{0.2}O₃ layer can be converted into the electrolyte layer 220. The firing conditions for the Li_{2.2}C_{0.8}B_{0.2}O₃ layer are not particularly limited, but the heating temperature can be set to 400° C. or higher and 600° C. or lower, and the heating time can be set to 1 hour or more and 3 hours or less.

### [5-3-3] Step S23

After Step S22, the process proceeds to Step S23.

In the step of forming the positive electrode 10 of Step S23, the positive electrode 10 is formed at one face 220a side of the electrolyte layer 220, that is, an opposite face side of the electrolyte layer 220 from a face thereof facing the negative electrode composite material 330. More specifically, for example, first, by using a vacuum deposition device or the like, a LiCoO₂ layer is formed at one face 220a of the electrolyte layer 220. Thereafter, a stacked body of the electrolyte layer 220 at which the LiCoO₂ layer is formed, and the negative electrode composite material 330 is fired so as to convert the crystal of the LiCoO₂ layer into a high-temperature phase crystal, whereby the LiCoO₂ layer can be converted into the positive electrode 10. The firing conditions for the LiCoO₂ layer are not particularly limited, but the heating temperature can be set to 400° C. or higher and 600° C. or lower, and the heating time can be set to 1 hour or more and 3 hours or less.

### [5-3-4] Step S24

After Step S23, the process proceeds to Step S24.

In the step of forming the current collectors 41 and 42 of Step S24, the current collector 41 is formed so as to come in contact with one face 10a of the positive electrode 10, that is, the face 10a of the positive electrode 10 at an opposite side from the face at which the electrolyte layer 220 is formed, and the current collector 42 is formed so as to come in contact with the other face of the negative electrode composite material 330, that is, a face 330b of the negative electrode composite material 330 at an opposite side from the face 330a at which the electrolyte layer 220 is formed.

The methods for forming the negative electrode composite material 330 and the electrolyte layer 220 are not limited to the above-mentioned methods. For example, the negative electrode composite material 330 and the electrolyte layer 220 may be formed as follows. That is, first, a slurry as a mixture of the solid composition according to the present disclosure, a binder, and a solvent is obtained. Then, the obtained slurry is fed to a fully automatic film applicator 500 and applied onto the base material 506, whereby an electrolyte forming sheet is formed. Thereafter, the electrolyte forming sheet and the negative electrode composite material forming sheet 330s formed in the same manner as described above are pressed in a stacked state and bonded to each other. Thereafter, a stacked sheet obtained by bonding the sheets to each other is punched to form a molded material, and the molded material is fired in an oxidizing atmosphere, whereby a stacked body of the negative electrode composite material 330 and the electrolyte layer 220 may be obtained.

### [5-4] Method for Producing Secondary Battery of Fourth Embodiment

Next, a method for producing the secondary battery according to the fourth embodiment will be described.

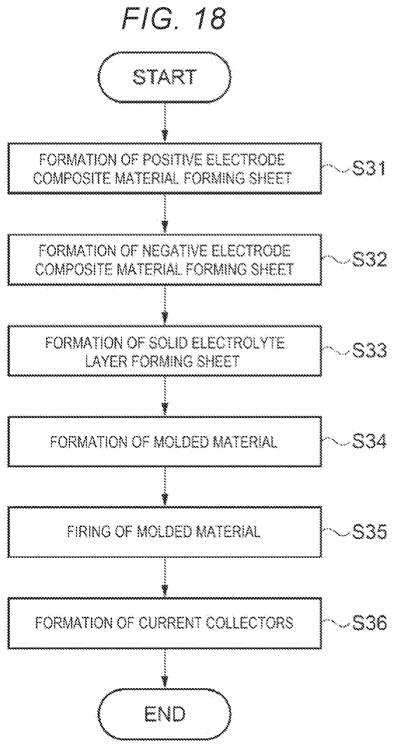

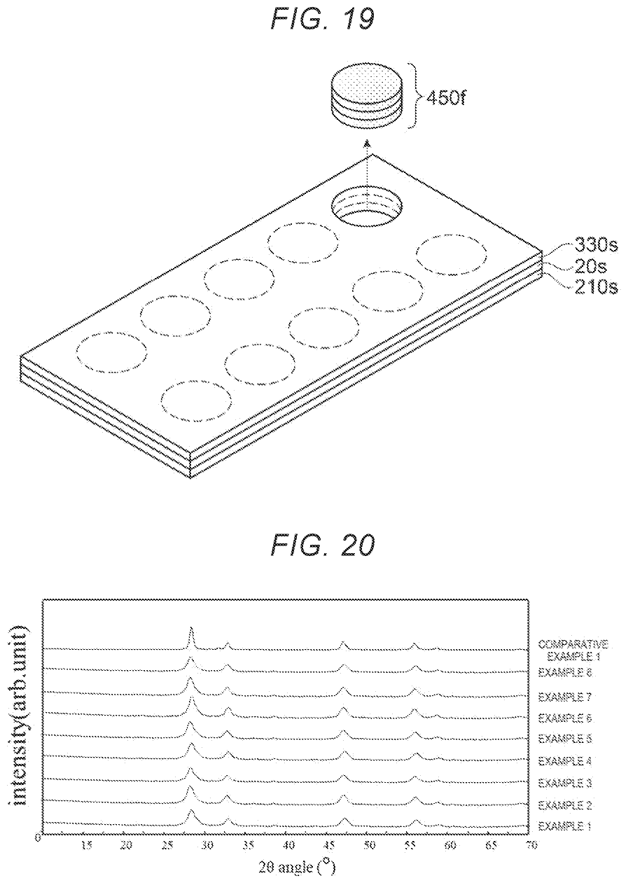

FIG. 18 is a flowchart showing the method for producing the lithium-ion battery as the secondary battery of the fourth embodiment, and FIG. 19 is a schematic view schematically showing the method for producing the lithium-ion battery as the secondary battery of the fourth embodiment.

Hereinafter, the method for producing the secondary battery according to the fourth embodiment will be described with reference to these drawings, but different points from the above-mentioned embodiments will be mainly described, and the description of the same matter will be omitted.

As shown in FIG. 18, the method for producing the lithium-ion battery 100 of this embodiment includes Step S31, Step S32, Step S33, Step S34, Step S35, and Step S36.

Step S31 is a step of forming a sheet for forming the positive electrode composite material 210. Step S32 is a step of forming a sheet for forming the negative electrode composite material 330. Step S33 is a step of forming a sheet for forming the solid electrolyte layer 20. Step S34 is a step of forming a molded material 450f of molding a stacked body of the sheet for forming the positive electrode composite material 210, the sheet for forming the negative electrode composite material 330, and the sheet for forming the solid electrolyte layer 20 into a predetermined shape. Step S35 is a step of firing the molded material 450f. Step S36 is a step of forming the current collectors 41 and 42.

In the following description, a description will be made by assuming that Step S32 is performed after Step S31, and Step S33 is performed after Step S32, however, the order of Step S31, Step S32, and Step S33 is not limited thereto, and the order of the steps may be changed, or the steps may be concurrently performed.

### [5-4-1] Step S31

In the step of forming a sheet for forming the positive electrode composite material 210 of Step S31, a positive electrode composite material forming sheet 210s that is the sheet for forming the positive electrode composite material 210 is formed.

The positive electrode composite material forming sheet 210s can be formed, for example, in the same manner as described in the above second embodiment.

The positive electrode composite material forming sheet 210s obtained in this step is preferably one obtained by removing the solvent from the slurry 210m used for forming the positive electrode composite material forming sheet 210s.

### [5-4-2] Step S32

After Step S31, the process proceeds to Step S32.

In the step of forming a sheet for forming the negative electrode composite material 330 of Step S32, a negative electrode composite material forming sheet 330s that is the sheet for forming the negative electrode composite material 330 is formed.

The negative electrode composite material forming sheet 330s can be formed, for example, in the same manner as described in the above third embodiment.

The negative electrode composite material forming sheet 330s obtained in this step is preferably one obtained by removing the solvent from the slurry 330m used for forming the negative electrode composite material forming sheet 330s.

### [5-4-3] Step S33

After Step S32, the process proceeds to Step S33.

In the step of forming a sheet for forming the solid electrolyte layer 20 of Step S33, a solid electrolyte forming sheet 20s that is the sheet for forming the solid electrolyte layer 20 is formed.

The solid electrolyte forming sheet 20s can be formed, for example, in the same manner as described in the above first embodiment.

The solid electrolyte forming sheet 20s obtained in this step is preferably one obtained by removing the solvent from the slurry 20m used for forming the solid electrolyte forming sheet 20s.

### [5-4-4] Step S34

After Step S33, the process proceeds to Step S34.

In the step of forming the molded material 450f of Step S34, the positive electrode composite material forming sheet 210s, the solid electrolyte forming sheet 20s, and the negative electrode composite material forming sheet 330s are pressed in a state of being stacked in this order and bonded to one another. Thereafter, as shown in FIG. 19, a stacked sheet obtained by bonding the sheets to one another is punched, whereby the molded material 450f is obtained.

### [5-4-5] Step S35

After Step S34, the process proceeds to Step S35.

In the step of firing the molded material 450f of Step S35, the molded material 450f is subjected to a heating step at a temperature of 700° C. or higher and 1000° C. or lower. By doing this, a portion constituted by the positive electrode composite material forming sheet 210s is converted into the positive electrode composite material 210, a portion constituted by the solid electrolyte forming sheet 20s is converted into the solid electrolyte layer 20, and a portion constituted by the negative electrode composite material forming sheet 330s is converted into the negative electrode composite material 330. That is, a fired body of the molded material 450f is a stacked body of the positive electrode composite material 210, the solid electrolyte layer 20, and the negative electrode composite material 330. The heating time and atmosphere in the heating step are as described above.

### [5-4-6] Step S36

After Step S35, the process proceeds to Step S36.

In the step of forming the current collectors 41 and 42 of Step S36, the current collector 41 is formed so as to come in contact with the face 210a of the positive electrode composite material 210, and the current collector 42 is formed so as to come in contact with the face 330b of the negative electrode composite material 330.

Hereinabove, preferred embodiments of the present disclosure have been described, however, the present disclosure is not limited thereto.

For example, the method for producing a solid composition according to the present disclosure may be applied to a method further including another step in addition to the steps as described above. More specifically, for example, in addition to the above-mentioned steps, the method may include a step of mixing a lithium compound other than a lithium oxoacid salt, that is, a lithium compound that is not an oxoacid compound with a composition containing at least a precursor oxide. Further, the method may include, for example, a drying step of removing a liquid component contained in the system after the precursor oxide production step.

Further, the method for producing a solid electrolyte according to the present disclosure may be applied to a method further including another step in addition to the steps as described above.

Further, when the present disclosure is applied to a secondary battery, the configuration of the secondary battery is not limited to those of the above-mentioned embodiments.

For example, when the present disclosure is applied to a secondary battery, the secondary battery is not limited to a lithium-ion battery, and may be, for example, a secondary battery in which a porous separator is provided between a positive electrode composite material and a negative electrode, and the separator is impregnated with an electrolyte solution.

Further, when the present disclosure is applied to a secondary battery, the production method therefor is not limited to those of the above-mentioned embodiments. For example, the order of the steps in the production of the secondary battery may be made different from that in the above-mentioned embodiments.

Further, in the above-mentioned embodiments, a description has been made by assuming that the solid electrolyte according to the present disclosure constitutes a part of a secondary battery, particularly a part of an all-solid-state lithium secondary battery that is an all-solid-state secondary battery, however, the solid electrolyte according to the present disclosure may constitute, for example, a part other than an all-solid-state secondary battery or may constitute a part other than a secondary battery.

### EXAMPLES

Next, specific Examples of the present disclosure will be described.

### [6] Production of Solid Composition

### Example 1

In this Example, a solid composition to be used in the production of a solid electrolyte represented by the formulation: Li_{6.3}La₃Zr_{1.3}Sb_{0.5}Ta_{0.2}O₁₂ was produced as follows.

First, lanthanum triisopropoxide as a lanthanum source, zirconium tetrabutoxide as a zirconium source, antimony tributoxide as an antimony source, and tantalum pentaethoxide as a tantalum source were mixed at ratios shown in Table 1, respectively, whereby a mixture was obtained. This mixture and 2-n-butoxyethanol as a solvent were mixed at a predetermined ratio, whereby a metal compound solution as a mixed solution in which the respective raw material compounds were dissolved was obtained.

The thus obtained metal compound solution as the mixed solution was subjected to a first heat treatment in the air at 140° C. for 20 minutes in a state of being placed in a beaker made of titanium, whereby a composition in a gel form was obtained.

Subsequently, the thus obtained composition in a gel form was subjected to a second heat treatment in the air at 540° C. for 20 minutes, whereby a precursor oxide that is a thermally decomposed product in an ash form was obtained.

Subsequently, the thus obtained precursor oxide and a solution prepared by dissolving lithium nitrate in 2-n-butoxyethanol were mixed according to the molar ratios of the respective metal elements in the compositional formula of the above solid electrolyte, whereby a mixture in a slurry form was obtained. This mixture was subjected to a heat treatment at 140° C. for 40 minutes to remove 2-n-butoxyethanol, whereby a solid composition was obtained.

### Example 2

In this Example, a solid composition to be used in the production of a solid electrolyte represented by the formulation: Li_{6.3}La₃Zr_{1.3}Sb_{0.5}Ta_{0.2}O₁₂ was produced as follows.

First, lanthanum triisopropoxide as a lanthanum source, zirconium tetrabutoxide as a zirconium source, antimony tributoxide as an antimony source, and tantalum pentaethoxide as a tantalum source were mixed at ratios shown in Table 1, respectively, whereby a mixture was obtained. This mixture and 2-n-butoxyethanol as a solvent were mixed at a predetermined ratio, whereby a metal compound solution as a mixed solution in which the respective raw material compounds were dissolved was obtained.

The thus obtained metal compound solution as the mixed solution was subjected to a first heat treatment in the air at 140° C. for 20 minutes in a state of being placed in a beaker made of titanium, whereby a composition in a gel form was obtained.

Subsequently, the thus obtained composition in a gel form was subjected to a second heat treatment in the air at 540° C. for 20 minutes, whereby a precursor oxide that is a thermally decomposed product in an ash form was obtained.

Subsequently, the thus obtained precursor oxide and a solution prepared by dissolving lithium sulfate monohydrate in 2-n-butoxyethanol were mixed according to the molar ratios of the respective metal elements in the compositional formula of the above solid electrolyte, whereby a mixture in a slurry form was obtained. This mixture was subjected to a heat treatment at 140° C. for 40 minutes to remove 2-n-butoxyethanol, whereby a solid composition was obtained.

### Example 3

In this Example, a solid composition to be used in the production of a solid electrolyte represented by the formulation: Li_{6.3}La₃Zr_{1.3}Sb_{0.5}Ta_{0.2}O₁₂ was produced as follows.

First, lanthanum triisopropoxide as a lanthanum source, zirconium tetrabutoxide as a zirconium source, antimony tributoxide as an antimony source, and tantalum pentaethoxide as a tantalum source were mixed at ratios shown in Table 1, respectively, whereby a mixture was obtained. This mixture and 2-n-butoxyethanol as a solvent were mixed at a predetermined ratio, whereby a metal compound solution as a mixed solution in which the respective raw material compounds were dissolved was obtained.

The thus obtained metal compound solution as the mixed solution was subjected to a first heat treatment in the air at 140° C. for 20 minutes in a state of being placed in a beaker made of titanium, whereby a composition in a gel form was obtained.

Subsequently, the thus obtained composition in a gel form was subjected to a second heat treatment in the air at 540° C. for 20 minutes, whereby a precursor oxide that is a thermally decomposed product in an ash form was obtained.

Subsequently, the thus obtained precursor oxide and lithium nitrate were weighed according to the molar ratios of the respective metal elements in the compositional formula of the above solid electrolyte, and ground and mixed in an agate mortar, whereby a solid composition was obtained.

### Example 4

In this Example, a solid composition to be used in the production of a solid electrolyte represented by the formulation: Li_{6.3}La₃Zr_{1.3}Sb_{0.5}Ta_{0.2}O₁₂ was produced as follows.

First, lanthanum triisopropoxide as a lanthanum source, zirconium tetrabutoxide as a zirconium source, antimony tributoxide as an antimony source, and tantalum pentaethoxide as a tantalum source were mixed at ratios shown in Table 2, respectively, whereby a mixture was obtained. This mixture and 2-n-butoxyethanol as a solvent were mixed at a predetermined ratio, whereby a metal compound solution as a mixed solution in which the respective raw material compounds were dissolved was obtained.

The thus obtained metal compound solution as the mixed solution was subjected to a first heat treatment in the air at 140° C. for 20 minutes in a state of being placed in a beaker made of titanium, whereby a composition in a gel form was obtained.

Subsequently, the thus obtained composition in a gel form was subjected to a second heat treatment in the air at 540° C. for 20 minutes, whereby a precursor oxide that is a thermally decomposed product in an ash form was obtained.

Subsequently, the thus obtained precursor oxide and lithium sulfate monohydrate were weighed according to the molar ratios of the respective metal elements in the compositional formula of the above solid electrolyte, and ground and mixed in an agate mortar, whereby a solid composition was obtained.

### Example 5

In this Example, a solid composition to be used in the production of a solid electrolyte represented by the formulation: Li_{6.3}La₃Zr_{1.3}Nb_{0.2}Sb_{0.5}O₁₂ was produced as follows.

First, lanthanum triisopropoxide as a lanthanum source, zirconium tetrabutoxide as a zirconium source, antimony tributoxide as an antimony source, and niobium pentaethoxide as a niobium source were mixed at ratios shown in Table 2, respectively, whereby a mixture was obtained. This mixture and 2-n-butoxyethanol as a solvent were mixed at a predetermined ratio, whereby a metal compound solution as a mixed solution in which the respective raw material compounds were dissolved was obtained.

The thus obtained metal compound solution as the mixed solution was subjected to a first heat treatment in the air at 140° C. for 20 minutes in a state of being placed in a beaker made of titanium, whereby a composition in a gel form was obtained.

Subsequently, the thus obtained composition in a gel form was subjected to a second heat treatment in the air at 540° C. for 20 minutes, whereby a precursor oxide that is a thermally decomposed product in an ash form was obtained.

Subsequently, the thus obtained precursor oxide and a solution prepared by dissolving lithium nitrate in 2-n-butoxyethanol were mixed according to the molar ratios of the respective metal elements in the compositional formula of the above solid electrolyte, whereby a mixture in a slurry form was obtained. This mixture was subjected to a heat treatment at 140° C. for 40 minutes to remove 2-n-butoxyethanol, whereby a solid composition was obtained.

### Example 6

In this Example, a solid composition to be used in the production of a solid electrolyte represented by the formulation: Li_{6.4}La₃Zr_{1.3}Nb_{0.3}Ta_{0.3}O₁₂ was produced as follows.

First, lanthanum triisopropoxide as a lanthanum source, zirconium tetrabutoxide as a zirconium source, niobium pentaethoxide as a niobium source, and tantalum pentaethoxide as a tantalum source were mixed at ratios shown in Table 2, respectively, whereby a mixture was obtained. This mixture and 2-n-butoxyethanol as a solvent were mixed at a predetermined ratio, whereby a metal compound solution as a mixed solution in which the respective raw material compounds were dissolved was obtained.

The thus obtained metal compound solution as the mixed solution was subjected to a first heat treatment in the air at 140° C. for 20 minutes in a state of being placed in a beaker made of titanium, whereby a composition in a gel form was obtained.

Subsequently, the thus obtained composition in a gel form was subjected to a second heat treatment in the air at 540° C. for 20 minutes, whereby a precursor oxide that is a thermally decomposed product in an ash form was obtained.

Subsequently, the thus obtained precursor oxide and a solution prepared by dissolving lithium nitrate in 2-n-butoxyethanol were mixed according to the molar ratios of the respective metal elements in the compositional formula of the above solid electrolyte, whereby a mixture in a slurry form was obtained. This mixture was subjected to a heat treatment at 140° C. for 40 minutes to remove 2-n-butoxyethanol, whereby a solid composition was obtained.

### Example 7

In this Example, a solid composition to be used in the production of a solid electrolyte represented by the formulation: Li_{6.3}La₃Zr_{1.3}Sb_{0.5}Ta_{0.2}O₁₂ was produced as follows.

First, zirconium tetrabutoxide as a zirconium source, antimony tributoxide as an antimony source, tantalum pentaethoxide as a tantalum source, and lanthanum triisopropoxide as a lanthanum source were mixed at ratios shown in Table 3, respectively, whereby a mixture was obtained. This mixture and 2-n-butoxyethanol as a solvent were mixed at a predetermined ratio, whereby a metal compound solution as a mixed solution in which the respective raw material compounds were dissolved was obtained.

The thus obtained metal compound solution as the mixed solution was subjected to a first heat treatment in the air at 140° C. for 20 minutes in a state of being placed in a beaker made of titanium, whereby a composition in a gel form was obtained.

Subsequently, the thus obtained composition in a gel form was subjected to a second heat treatment in the air at 540° C. for 20 minutes, whereby a precursor oxide that is a thermally decomposed product in an ash form was obtained.

Subsequently, the thus obtained precursor oxide and a solution prepared by dissolving lithium sulfate monohydrate and lithium nitrate in 2-n-butoxyethanol were mixed according to the molar ratios of the respective metal elements in the compositional formula of the above solid electrolyte, whereby a mixture in a slurry form was obtained. This mixture was subjected to a heat treatment at 140° C. for minutes to remove 2-n-butoxyethanol, whereby a solid composition was obtained.

### Example 8

In this Example, a solid composition to be used in the production of a solid electrolyte represented by the formulation: Li_{6.3}La₃Zr_{1.3}Sb_{0.5}Ta_{0.2}O₁₂ was produced as follows.

First, zirconium tetrabutoxide as a zirconium source, antimony tributoxide as an antimony source, tantalum pentaethoxide as a tantalum source, and lanthanum triisopropoxide as a lanthanum source were mixed at ratios shown in Table 3, respectively, whereby a mixture was obtained. This mixture and 2-n-butoxyethanol as a solvent were mixed at a predetermined ratio, whereby a metal compound solution as a mixed solution in which the respective raw material compounds were dissolved was obtained.

The thus obtained metal compound solution as the mixed solution was subjected to a first heat treatment in the air at 140° C. for 20 minutes in a state of being placed in a beaker made of titanium, whereby a composition in a gel form was obtained.

Subsequently, the thus obtained composition in a gel form was subjected to a second heat treatment in the air at 440° C. for 20 minutes, whereby a precursor oxide that is a thermally decomposed product in an ash form was obtained.

Subsequently, the thus obtained precursor oxide and a solution prepared by dissolving lithium nitrate monohydrate in 2-n-butoxyethanol were mixed according to the molar ratios of the respective metal elements in the compositional formula of the above solid electrolyte, whereby a mixture in a slurry form was obtained. This mixture was subjected to a heat treatment at 140° C. for 40 minutes to remove 2-n-butoxyethanol, whereby a solid composition was obtained.

### Comparative Example 1

In this Comparative Example, a solid composition to be used in the production of a solid electrolyte represented by the formulation: Li_{6.3}La₃Zr_{1.3}Sb_{0.5}Ta_{0.2}O₁₂ was produced as follows.

First, lanthanum triisopropoxide as a lanthanum source, zirconium tetrabutoxide as a zirconium source, antimony tributoxide as an antimony source, tantalum pentaethoxide as a tantalum source, and lithium ethoxide as a lithium source were mixed at ratios shown in Table 3, respectively, whereby a mixture was obtained. This mixture and 2-n-butoxyethanol as a solvent were mixed at a predetermined ratio, whereby a metal compound solution as a mixed solution in which the respective raw material compounds were dissolved was obtained.

The thus obtained metal compound solution as the mixed solution was subjected to a first heat treatment in the air at 140° C. for 20 minutes in a state of being placed in a beaker made of titanium, whereby a composition in a gel form was obtained.

Subsequently, the thus obtained composition in a gel form was subjected to a second heat treatment in the air at 540° C. for 20 minutes, whereby a precursor oxide that is a thermally decomposed product in an ash form was obtained.

The thus obtained precursor oxide was constituted by a pyrochlore-type crystal phase. In this Comparative Example, this precursor oxide was used as the solid composition. That is, the solid composition according to this Comparative Example does not contain an oxoacid compound.

The raw materials used in the preparation of the solid compositions of the respective Examples and Comparative Example, and the production conditions for the solid compositions are collectively shown in Tables 1, 2, and 3, and the conditions for the solid compositions of the respective Examples and Comparative Example are collectively shown in Table 4. Further, in Table 4, the value of XO/XP, the value of XL/XP, and the value of XO/XL when the content of the oxoacid compound in the solid composition is represented by XO [mass %] the content of the precursor oxide in the solid composition is represented by XP [mass %], and the content of the lithium compound in the solid composition is represented by XL [mass %] are also shown. Note that in all the solid compositions obtained in the respective Examples and Comparative Example, the content of the solvent was 0.1 mass % or less. Further, when a portion of each of the precursor oxides used in the production of the solid compositions according to the respective Examples was measured by TG-DTA at a temperature raising rate of 10° C./min, only one exothermic peak was observed in a range of 300° C. or higher and 1,000° C. or lower in all cases. From the results, it can be said that the precursor oxides constituting the solid compositions according to the respective Examples are constituted by a substantially single crystal phase. Further, the content of the liquid component in each of the solid compositions of the respective Examples and Comparative Example was 100 ppm or less.

TABLE 1

| | | | | | | First heat | | | |
|---|---|---|---|---|---|---|---|---|---|
| | Raw material compound | | | Solvent | | treatment | Second heat treatment | | |
| | | | Used amount | | Used amount | Heating | Heating | Heating | |
| | | | [parts | | [parts | temperature | temperature | time | Atmo- |
| | | Type | by mass] | Type | by mass] | [° C.] | [° C.] | [min] | sphere |
| Example 1 | Metal compounds | zirconium tetrabutoxide | 5.87 | 2-n- | 261 | 140 | 540 | 20 | air |
| | used in preparation | antimony tributoxide | 1.71 | butoxy- | | | | | |
| | of metal compound | tantalum pentaethoxide | 0.81 | ethanol | | | | | |
| | solution | lanthanum triisopropoxide | 9.48 | | | | | | |
| | Oxoacid compound | lithium nitrate | 4.34 | | | | | | |
| | mixed with | | | | | | | | |
| | precursor oxide | | | | | | | | |
| Example 2 | Metal compounds | zirconium tetrabutoxide | 5.87 | 2-n- | 320 | 140 | 540 | 20 | air |
| | used in preparation | antimony tributoxide | 1.71 | butoxy- | | | | | |
| | of metal compound | tantalum pentaethoxide | 0.81 | ethanol | | | | | |
| | solution | lanthanum triisopropoxide | 9.48 | | | | | | |
| | Oxoacid compound | lithium sulfate monohydrate | 4.03 | | | | | | |
| | mixed with | | | | | | | | |
| | precursor oxide | | | | | | | | |
| Example 3 | Metal compounds | zirconium tetrabutoxide | 5.87 | 2-n- | 319 | 140 | 540 | 20 | air |
| | used in preparation | antimony tributoxide | 1.71 | butoxy- | | | | | |
| | of metal compound | tantalum pentaethoxide | 0.81 | ethanol | | | | | |
| | solution | lanthanum triisopropoxide | 9.48 | | | | | | |
| | Oxoacid compound | lithium nitrate | 4.34 | not used | | | | | |
| | mixed with | | | | | | | | |
| | precursor oxide | | | | | | | | |

TABLE 2

| | | | | | | First heat | | | |
|---|---|---|---|---|---|---|---|---|---|
| | Raw material compound | | | Solvent | | treatment | Second heat treatment | | |
| | | | Used amount | | Used amount | Heating | Heating | Heating | |
| | | | [parts | | [parts by | temperature | temperature | time | Atmo- |
| | | Type | by mass] | Type | mass] | [° C.] | [° C.] | [min] | sphere |
| Example 4 | Metal compounds | zirconium tetrabutoxide | 5.87 | 2-n- | 320 | 140 | 540 | 20 | air |
| | used in preparation | antimony tributoxide | 1.71 | butoxy- | | | | | |
| | of metal compound | tantalum pentaethoxide | 0.81 | ethanol | | | | | |
| | solution | lanthanum triisopropoxide | 9.48 | | | | | | |
| | Oxoacid compound | lithium sulfate monohydrate | 4.03 | not used | | | | | |
| | mixed with | | | | | | | | |
| | precursor oxide | | | | | | | | |
| Example 5 | Metal compounds | zirconium tetrabutoxide | 5.87 | 2-n- | 328 | 140 | 540 | 20 | air |
| | used in preparation | niobium pentaethoxide | 0.64 | butoxy- | | | | | |
| | of metal compound | antimony tributoxide | 1.71 | ethanol | | | | | |
| | solution | lanthanum triisopropoxide | 9.48 | | | | | | |
| | Oxoacid compound | lithium nitrate | 4.34 | | | | | | |
| | mixed with | | | | | | | | |
| | precursor oxide | | | | | | | | |
| Example 6 | Metal compounds | zirconium tetrabutoxide | 6.32 | 2-n- | 322 | 140 | 540 | 20 | air |
| | used in preparation | niobium pentaethoxide | 0.95 | butoxy- | | | | | |
| | of metal compound | tantalum pentaethoxide | 1.22 | ethanol | | | | | |
| | solution | lanthanum triisopropoxide | 9.48 | | | | | | |
| | Oxoacid compound | lithium nitrate | 4.41 | | | | | | |
| | mixed with | | | | | | | | |
| | precursor oxide | | | | | | | | |

TABLE 3

| | | | | | | First heat | | | |
|---|---|---|---|---|---|---|---|---|---|
| | Raw material compound | | | Solvent | | treatment | Second heat treatment | | |
| | | | Used amount | | Used amount | Heating | Heating | Heating | |
| | | | [parts | | [parts | temperature | temperature | time | Atmo- |
| | | Type | by mass] | Type | by mass] | [° C.] | [° C.] | [min] | sphere |
| Example 7 | Metal compounds | zirconium tetrabutoxide | 5.87 | 2-n- | 327 | 140 | 540 | 20 | air |
| | used in preparation | antimony tributoxide | 1.71 | butoxy- | | | | | |
| | of metal compound | tantalum pentaethoxide | 0.81 | ethanol | | | | | |
| | solution | lanthanum triisopropoxide | 9.48 | | | | | | |
| | Oxoacid compound | lithium sulfate monohydrate | 2.02 | | | | | | |
| | mixed with | lithium nitrate | 2.17 | | | | | | |
| | precursor oxide | | | | | | | | |
| Example 8 | Metal compounds | zirconium tetrabutoxide | 5.87 | 2-n- | 261 | 140 | 440 | 20 | air |
| | used in preparation | antimony tributoxide | 1.71 | butoxy- | | | | | |
| | of metal compound | tantalum pentaethoxide | 0.81 | ethanol | | | | | |
| | solution | lanthanum triisopropoxide | 9.48 | | | | | | |
| | Oxoacid compound | lithium nitrate monohydrate | 4.34 | | | | | | |
| | mixed with | | | | | | | | |
| | precursor oxide | | | | | | | | |
| Compar- | Metal compounds | antimony tributoxide | 1.71 | 2-n- | 322 | 140 | 540 | 20 | air |
| ative | used in preparation | tantalum pentaethoxide | 0.81 | butoxy- | | | | | |
| Example 1 | of metal compound | zirconium tetrabutoxide | 5.87 | ethanol | | | | | |
| | solution | lanthanum triisopropoxide | 9.48 | | | | | | |
| | Oxoacid compound | lithium ethoxide | 3.28 | | | | | | |
| | mixed with | | | | | | | | |
| | precursor oxide | | | | | | | | |

TABLE 4

| | Precursor oxide | | | Lithium compound | | Oxoacid compound | | | | |
|---|---|---|---|---|---|---|---|---|---|---|
| | | Crystal grain | Content XP | | Content XL | | Content XO | | | |
| | Crystal phase | diameter [nm] | [mass %] | Formulation | [mass %] | Formulation | [mass %] | XO/XP | XL/XP | XO/XL |
| Example 1 | pyrochlore-type | 130 | 98.67 | LiNO₃ | 1.33 | LiNO₃ | 1.33 | 0.0135 | 0.0135 | 1.00 |
| Example 2 | pyrochlore-type | 90 | 98.67 | Li₂SO₄•H₂O | 1.33 | Li₂SO₄•H₂O | 1.33 | 0.0135 | 0.0135 | 1.00 |
| Example 3 | pyrochlore-type | 130 | 98.67 | LiNO₃ | 1.33 | LiNO₃ | 1.33 | 0.0135 | 0.0135 | 1.00 |
| Example 4 | pyrochlore-type | 90 | 98.67 | Li₂SO₄•H₂O | 1.33 | Li₂SO₄•H₂O | 1.33 | 0.0135 | 0.0135 | 1.00 |
| Example 5 | pyrochlore-type | 40 | 98.67 | LiNO₃ | 1.33 | LiNO₃ | 1.33 | 0.0135 | 0.0135 | 1.00 |
| Example 6 | pyrochlore-type | 40 | 98.67 | LiNO₃ | 1.33 | LiNO₃ | 1.33 | 0.0135 | 0.0135 | 1.00 |
| Example 7 | pyrochlore-type | 40 | 94.09 | LiNO₃ | 1.33 | LiNO₃ | 1.33 | 0.0135 | 0.0135 | 1.00 |
| | | | | | | La(NO₃)₃•6H₂O | 4.58 | 0.0480 | 1.00 | 0.0480 |
| Example 8 | pyrochlore-type | 50 | 98.67 | LiNO₃ | 1.33 | LiNO₃ | 1.33 | 0.0135 | 0.0135 | 1.00 |
| Compar- | pyrochlore-type | 40 | 100 | same as | 100 | — | 0 | 0 | 1.00 | 0 |
| ative | | | | precursor | | | | | | |
| Example 1 | | | | oxide | | | | | | |

With respect to the precursor oxides constituting the solid compositions according to the respective Examples and Comparative Example, an analysis was performed using an X-ray diffractometer X′Pert-PRO manufactured by Koninklijke Philips N. V., and X-ray diffraction patterns were obtained. The X-ray diffraction patterns of the precursor oxides constituting the solid compositions according to the respective Examples and Comparative Example are shown in FIG. 20. As shown in FIG. 20, the diffraction angles 2θ in the X-ray diffraction patterns of the precursor oxides constituting the solid compositions according to the respective Examples were 28.4°, 32.88°, 47.2°, 56.01°, and 58.73°.

### [7] Production of Solid Electrolyte

By using the solid compositions according to the respective Examples and Comparative Example, solid electrolytes were produced as follows.

First, 1 g of a sample was taken out from each of the solid compositions.

Subsequently, each sample thereof was filled in a pellet die with an exhaust port having an inner diameter of mm manufactured by Specac, Inc., followed by press molding under a load of 6 kN, whereby a pellet as a molded material was obtained. The obtained pellet was placed in a crucible made of alumina, and fired in an air atmosphere at 900° C. for 8 hours, whereby a solid electrolyte in a pellet form was obtained.

With respect to the solid electrolytes obtained as described using the solid compositions according to the respective Examples and Comparative Example, an analysis was performed using an X-ray diffractometer X′Pert-PRO manufactured by Koninklijke Philips N. V., and X-ray diffraction patterns were obtained.

As a result, it was confirmed that in the respective Examples, the precursor oxide contained in the solid composition and the solid electrolyte are constituted by mutually different crystal phases.

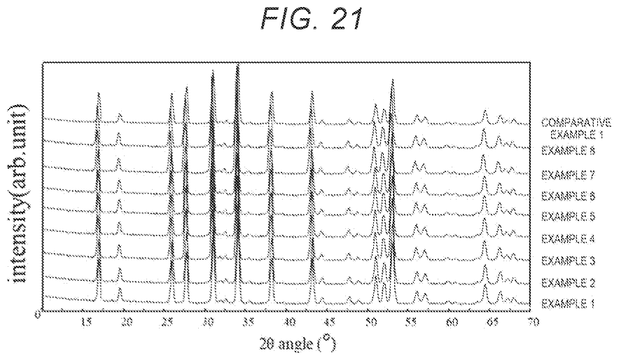

The X-ray diffraction patterns of the solid electrolytes according to the respective Examples and Comparative Example are shown in FIG. 21.

From these results, it was confirmed that in the respective Examples, the precursor oxide contained in the solid composition is constituted by a crystal phase which is different from the crystal phase of the solid electrolyte formed using the solid composition.

In Table 5, the formulation and the crystal phase of each of the solid electrolytes according to the respective Examples and Comparative Example are collectively shown. Note that the content of the oxoacid compound in each of the solid electrolytes according to the respective Examples and Comparative Example was 10 ppm or less.

TABLE 5

| | Formulation | Crystal phase |
|---|---|---|
| Example 1 | Li_{6.3}La₃Zr_{1.3}Sb_{0.5}Ta_{0.2}O₁₂ | cubic garnet-type |
| Example 2 | Li_{6.3}La₃Zr_{1.3}Sb_{0.5}Ta_{0.2}O₁₂ | cubic garnet-type |
| Example 3 | Li_{6.3}La₃Zr_{1.3}Sb_{0.5}Ta_{0.2}O₁₂ | cubic garnet-type |
| Example 4 | Li_{6.3}La₃Zr_{1.3}Sb_{0.5}Ta_{0.2}O₁₂ | cubic garnet-type |
| Example 5 | Li_{6.3}La₃Zr_{1.3}Nb_{0.2}Sb_{0.5}O₁₂ | cubic garnet-type |
| Example 6 | Li_{6.4}La₃Zr_{1.3}Nb_{0.3}Ta_{0.3}O₁₂ | cubic garnet-type |
| Example 7 | Li_{6.3}La₃Zr_{1.3}Sb_{0.5}Ta_{0.2}O₁₂ | cubic garnet-type |
| Example 8 | Li_{6.3}La₃Zr_{1.3}Sb_{0.5}Ta_{0.2}O₁₂ | cubic garnet-type |
| Comparative | Li_{6.3}La₃Zr_{1.3}Sb_{0.5}Ta_{0.2}O₁₂ | cubic garnet-type |
| Example 1 | | |

### [8] Evaluation

With respect to the solid electrolytes in a pellet form according to the respective Examples and Comparative Example obtained as described above, the following evaluation was performed.

### [8-1] Ion Conductivity

With respect to each of the solid electrolytes in a pellet form according to the respective Examples and Comparative Example obtained in the above [7], a lithium metal foil having a diameter of 8 mm (manufactured by Honjo Chemical Corporation) was bonded to both faces, whereby activated electrodes were formed. Then, an AC impedance was measured using an AC impedance analyzer Solartron 1260 (manufactured by Solartron Analytical, Inc.), and the lithium ion conductivity was determined. The measurement was performed at an AC amplitude of 10 mV in a frequency range from 10⁷ Hz to 10⁻¹ Hz. The lithium ion conductivity obtained by the measurement shows the total lithium ion conductivity including the bulk lithium ion conductivity and the grain boundary lithium ion conductivity in each solid electrolyte.

These results are collectively shown in Table 6.

TABLE 6

| | Ion conductivity (mS/cm) |
|---|---|
| Example 1 | 1.3 |
| Example 2 | 1.1 |
| Example 3 | 0.9 |
| Example 4 | 0.5 |
| Example 5 | 1.2 |
| Example 6 | 0.8 |
| Example 7 | 0.8 |
| Example 8 | 0.6 |
| Comparative | 0.04 |
| Example 1 | |

As apparent from Table 6, excellent results were obtained according to the present disclosure. On the other hand, satisfactory results could not be obtained in Comparative Example.

What is claimed is:

1. A method for producing a solid composition to be used for forming a solid electrolyte having a first crystal phase, the method comprising:
producing an oxide constituted by a second crystal phase that is different from the first crystal phase at normal temperature and normal pressure; and
mixing the oxide with an oxoacid compound.

2. The method for producing a solid composition according to claim 1, wherein the oxoacid compound contains at least one of a nitrate ion and a sulfate ion as an oxoanion.

3. The method for producing a solid composition according to claim 1, wherein when M is at least one type of element selected from the group consisting of Nb, Ta, and Sb,
the solid composition contains Li, La, Zr, and M, and
the ratio of substance amounts of Li, La, Zr, and M contained in the solid composition is 7-x:3:2-x:x, and a relationship: 0<x<2.0 is satisfied.

4. The method for producing a solid composition according to claim 1, wherein diffraction angles 2θ in an X-ray diffraction pattern of the oxide are 28.4°, 32.88°, 47.2°, 56.01°, and 58.73°.

5. The method for producing a solid composition according to claim 1, wherein
the second crystal phase is a pyrochlore-type crystal, and
the first crystal phase is a cubic garnet-type crystal.

6. The method for producing a solid composition according to claim 1, wherein the oxide has a crystal grain diameter of 10 nm or more and 200 nm or less.

7. A method for producing a solid electrolyte, comprising:
producing a solid composition by the method according to claim 1; and
heating the solid composition at a temperature of 700° C. or higher and 1000° C. or lower.
